(19) United States
(12) Patent Application Publication
(10) Pub. No.: US 2026/0064157 A1
(43) Pub. Date: Mar. 5, 2026

(54) METHOD FOR CONTROLLING OPERATION OF DISPLAY AREAS IN FOLDABLE DEVICE AND ELECTRONIC DEVICE THEREOF

(71) Applicant: Samsung Display Co., LTD., Yongin-si (KR)

(72) Inventors: Jee Eun KIM, Yongin-si (KR); Young Seok SEO, Yongin-si (KR)

(21) Appl. No.: 19/174,791

(22) Filed: Apr. 9, 2025

(30) Foreign Application Priority Data
Sep. 4, 2024 (KR) 10-2024-0120080

(51) Int. Cl. G06F 1/16; G06F 3/044; G06F 3/04817

(52) U.S. Cl. CPC G06F 1/1652; G06F 1/1677; G06F 3/044; G06F 3/04817; G06F 2203/04102

(57) ABSTRACT

A method for controlling an operation of a foldable device including a first display area and a second display area divided based on a foldable area, and a third display area, includes: detecting that an angle between the first display area and the second display area is unfolded to a first value within a first angular range; displaying a graphical interface of a first function in the third display area based on the first value; executing a selected second function based on a user input selecting the second function in the graphical interface; detecting that the angle between the first display area and the second display area is changed to a second value within a second angular range; and performing a third function through at least a partial area of the first display area or the second display area based on the second value.

### CROSS-REFERENCE TO RELATED APPLICATION

The present application claims priority to and the benefit of Korean Patent Application No. 10-2024-0120080, filed on Sep. 4, 2024, in the Korean Intellectual Property Office, the entire disclosure of which is incorporated by reference herein.

### BACKGROUND

### 1. Field

Aspects of embodiments of the present disclosure relate to a method for controlling an operation of display areas in a foldable device, and an electronic device thereof.

A foldable smartphone may have a main display formed inside the smartphone, and may include a separate display formed outside the smartphone to provide various information of the smartphone while in a folded state.

Major factors for purchasing the foldable smartphone may include a trendy design and a trendy color thereof, and thus, may be targeted to younger users. However, the foldable smartphone equipped with a plurality of displays may be expensive (e.g., may be cost prohibitive), and some limitations in terms of design may occur due to the external display.

The above information disclosed in this Background section is for enhancement of understanding of the background of the present disclosure, and therefore, it may contain information that does not constitute prior art.

### SUMMARY

Embodiments of the present disclosure may be directed to a method for controlling an operation of each display area of a foldable device based on an unfolding angle of a flexible display capable of being folded and unfolded in the foldable device, and an electronic device thereof.

According to one or more embodiments of the present disclosure, a method for controlling an operation of a foldable device including a first display area and a second display area on a first plane of a flexible display and divided based on a foldable area in the flexible display, and a third display area on a second plane extending from the first plane at a predetermined angle toward the second display area from the outside, includes: detecting that an angle between the first display area and the second display area is unfolded to a first value within a first angular range; displaying a graphical interface of a first function in the third display area based on the first value; executing a selected second function based on a user input selecting the second function in the graphical interface; detecting that the angle between the first display area and the second display area is changed to a second value within a second angular range; and performing a third function through at least a partial area of the first display area or the second display area based on the second value.

In an embodiment, the first display area and the second display area may be adjacent to each other based on the foldable area including a hinge, and the third display area may be bent at the predetermined angle with respect to the second display area.

In an embodiment, the graphical interface of the first function may include an icon or a gesture input interface configured to call the second function, and the user input may include selecting the icon or inputting a touch gesture to call the second function into the gesture input interface.

In an embodiment, a maximum value of the first angular range may include a value smaller than a minimum value of the second angular range.

In an embodiment, the third function may be determined based on the executed second function and the second angular range.

In an embodiment, when the second value is a maximum value of the angle that can be formed between the first display area and the second display area, the performing of the third function through at least a partial area of the first display area or the second display area may include displaying a control interface configured to control an operation of the third function in the third display area.

In an embodiment, the graphical interface of the first function may include at least one multi-icon configured to call two or more programs, and the user input may include selecting the multi-icon through a touch gesture.

In an embodiment, the performing of the third function through at least a partial area of the first display area or the second display area may include: dividing area sizes of each of graphical interfaces corresponding to two or more programs of the selected multi-icon corresponding to the second value; and displaying the graphical interfaces in the first display area and the second display area.

In an embodiment, before the detecting of the angle between the first display area and the second display area is changed to the second value within the second angular range, the method may further include: detecting that the first display area and the second display area are unfolded to a third value within a third angular range; displaying a graphical interface of a fourth function corresponding to the third angular range in the third display area; and executing a selected fifth function based on a user input selecting the fifth function in the graphical interface of the third function. The performing of the third function through at least a partial area of the first display area or the second display area may include: dividing area sizes of each of the graphical interface of the second function and a graphical interface of the fifth function corresponding to the second value; and displaying the graphical interfaces of the second function and the fifth function in the first display area and the second display area. Each of the graphical interface of the first function and the graphical interface of the fourth function may include at least one icon configured to call a program.

In an embodiment, the first angular range and the third angular range may not overlap with each other, and a maximum value of the first angular range and a maximum value of the third angular range may be smaller than a minimum value of the second angular range.

According to one or more embodiments of the present disclosure, an electronic device for controlling an operation of display areas in a foldable device, includes: a first display area and a second display area on a first plane of a flexible display, and divided based on a foldable area in the flexible display; a third display area on a second plane extending from the first plane at a predetermined angle toward the second display area from the outside; a storage device configured to store content; and a processor to process the content to be displayed on the flexible display. The processor is configured to: detect that an angle between the first display area and the second display area is unfolded to a first value within a first angular range; display a graphical interface of a first function in the third display area based on the first value; execute a selected second function based on a user input selecting the second function in the graphical interface; detect that the angle between the first display area and the second display area is changed to a second value within a second angular range; and perform a third function through at least a partial area of the first display area or the second display area based on the second value.

In an embodiment, the electronic device may further include a hinge configured to guide an unfolding of the first display area and the second display area. The first display area and the second display area may be adjacent to each other based on the foldable area defined by the hinge, and the third display area may be bent at the predetermined angle with respect to the second display area.

In an embodiment, the graphical interface of the first function may include an icon or a gesture input interface configured to call the second function, and the processor may be configured to acquire the user input selecting the icon or inputting a touch gesture to call the second function into the gesture input interface.

In an embodiment, a maximum value of the first angular range may be smaller than a minimum value of the second angular range.

In an embodiment, the third function may be determined based on the executed second function and the second angular range.

In an embodiment, when the second value is a maximum value that the angle can be formed between the first display area and the second display area, the processor may be configured to display a control interface configured to control an operation of the third function in the third display area.

In an embodiment, the graphical interface of the first function may include at least one multi-icon configured to call two or more programs, and the processor may be configured to acquire the user input selecting the multi-icon through a touch gesture.

In an embodiment, the processor may be configured to perform the third function by dividing area sizes of each of graphical interfaces corresponding to two or more programs of the selected multi-icon corresponding to the second value, and displaying the graphical interfaces in the first display area and the second display area.

In an embodiment, before the detecting that the angle between the first display area and the second display area is changed to the second value within the second angular range, the processor may be configured to: detect that the first display area and the second display area are unfolded to a third value within a third angular range; display a graphical interface of a fourth function corresponding to the third angular range in the third display area; and execute a selected fifth function based on a user input selecting the fifth function in the graphical interface of the third function. The processor may be further configured to perform the third function by dividing area sizes of each of the graphical interface of the second function and a graphical interface of the fifth function corresponding to the second value, and displaying the graphical interfaces in the first display area and the second display area. Each of the graphical interface of the first function and the graphical interface of the fourth function may include at least one icon configured to call a program.

In an embodiment, the first angular range and the third angular range may not overlap with each other, and a maximum value of the first angular range and a maximum value of the third angular range may be smaller than a minimum value of the second angular range.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 is a block diagram schematically illustrating a device according to an embodiment of the present disclosure;

FIG. 2 is a perspective view schematically illustrating the device according to an embodiment of the present disclosure;

FIG. 3 is a perspective view schematically illustrating the device according to an embodiment of the present disclosure;

FIG. 4 is a view schematically illustrating a state in which a display is being folded/unfolded at various angles in the device according to an embodiment of the present disclosure;

FIG. 5 is a flowchart illustrating an operation for controlling graphical interfaces to be displayed in divided display areas of a flexible display in the device according to an embodiment of the present disclosure;

FIG. 6 is a flowchart illustrating an operation for controlling graphical interfaces to be displayed in the divided display areas of the flexible display in the device according to an embodiment of the present disclosure;

FIG. 7 is a perspective view illustrating an operation for obtaining a user input through an external display area of the flexible display in the device according to an embodiment of the present disclosure;

FIGS. 8 and 9 are perspective views illustrating operations for displaying graphical interfaces of functions executed based on unfolding of the foldable display area in the device according to some embodiments of the present disclosure;

FIGS. 10 and 11 are perspective views illustrating operations for controlling detailed functions of the functions executed based on unfolding of the foldable display area in the device using an external display area according to some embodiments of the present disclosure;

FIG. 12 is a flowchart illustrating an operation for controlling graphical interfaces to be displayed in the divided display areas of the flexible display in the device according to an embodiment of the present disclosure;

FIG. 13 is a perspective view illustrating an operation for displaying a graphical interface of a function executed based on unfolding of the foldable display area in the device according to an embodiment of the present disclosure;

FIG. 14 is a flowchart illustrating an operation for controlling graphical interfaces displayed in the divided display areas of the flexible display in the device according to an embodiment of the present disclosure;

FIG. 15 is a perspective view illustrating an operation for displaying graphical interfaces of functions executed based on unfolding of the foldable display area in the device according to an embodiment of the present disclosure;

FIG. 16 is a flowchart illustrating an operation for controlling graphical interfaces displayed in the divided display areas of the flexible display in the device according to an embodiment of the present disclosure;

FIG. 17 is a perspective view illustrating an operation for displaying graphical interfaces of functions executed based on unfolding of the foldable display area in the device according to an embodiment of the present disclosure;

FIG. 18 is a flowchart illustrating an operation for controlling graphical interfaces displayed in the divided display areas of the flexible display in the device according to an embodiment of the present disclosure;

FIGS. 19-21 are perspective views illustrating operations for displaying a graphical interface of a first function based on each of unfolding angles of the foldable display area in the device according to some embodiments of the present disclosure;

FIG. 22 is a perspective view illustrating an operation for displaying a graphical interface of a second function selected from the graphical interface of the first function in the foldable display area in the device according to an embodiment of the present disclosure;

FIG. 23 is a flowchart illustrating an operation for controlling graphical interfaces to be displayed in the divided display areas of the flexible display in the device according to an embodiment of the present disclosure;

FIG. 24 is a perspective view illustrating an operation for selecting the second function through the graphical interface of the first function displayed based on each of the unfolding angles of the foldable display area in the device according to an embodiment of the present disclosure;

FIG. 25 is a perspective view illustrating an operation for displaying a plurality of graphical interfaces of a plurality of second functions selected from a plurality of graphical interfaces of a plurality of first functions in the foldable display area in the device according to an embodiment of the present disclosure;

FIG. 26 is a flowchart illustrating an operation for controlling graphical interfaces to be displayed in the divided display areas of the flexible display in the device according to an embodiment of the present disclosure;

FIG. 27 is a perspective view illustrating an operation for displaying the graphical interface of the first function based on the unfolding angle of the foldable display area in the device according to an embodiment of the present disclosure; and

FIGS. 28-30 are perspective views illustrating operations for displaying graphical interfaces for the plurality of second functions on the foldable display area based on the unfolding angle of the foldable display area in a device according to some embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

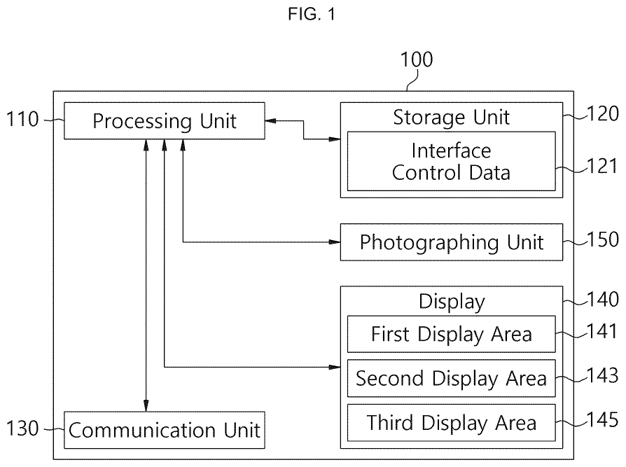

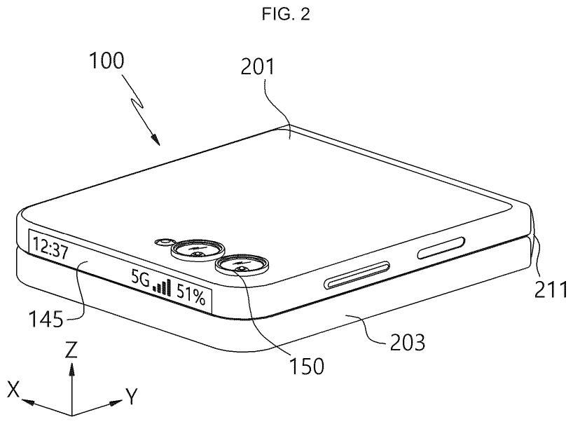

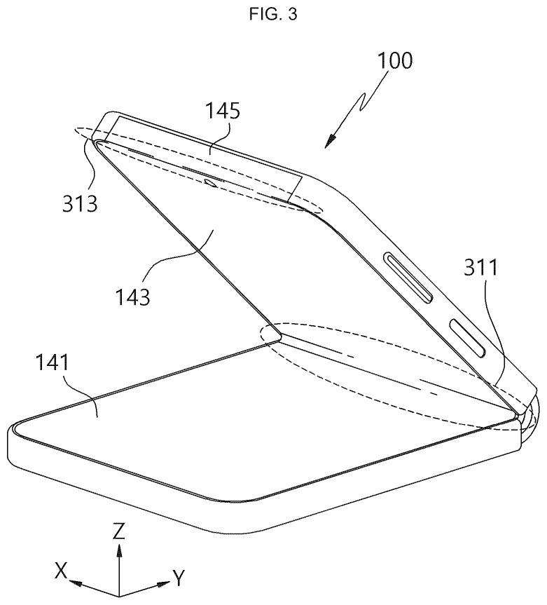

FIG. 1 is a block diagram schematically illustrating a device according to an embodiment of the present disclosure. FIG. 2 is a perspective view schematically illustrating the device according to an embodiment of the present disclosure. FIG. 3 is a perspective view schematically illustrating the device according to an embodiment of the present disclosure. For example, FIG. 2 may schematically illustrate some of the external configuration of the device, and FIG. 3 may schematically illustrate some of the external and internal configurations of the device.

Referring to FIG. 1, the foldable device 100 (hereinafter, referred to as a device 100) may include a processing unit (e.g., a processor) 110, a storage unit (e.g., a storage device or a memory) 120, a communication unit (e.g., a communication device) 130, a display 140, and a photographing unit (e.g., a camera) 150.

The processing unit 110 includes at least one processor (or controller), and may process control commands related to the operation of the display 140 through at least one program (e.g., an application, a tool, a plug-in, software, or the like).

For example, the processing unit 110 may perform a designated operation based on unfolding angles of the flexible display 140 that may be folded (or unfolded) and a user input. As such, data (e.g., interface control data 121) related to the operation of the display 140 may be stored in the storage unit 120.

The processing unit 110 may sense (e.g., may detect) the unfolding angle of the display 140.

As such, in some embodiments, the device 100 may further include at least one sensor for detecting the unfolded state (e.g., an unfolding angle) of the display 140.

In more detail, the device 100 may include at least one sensor capable of determining a folding or unfolding (e.g., folded/unfolded) angle of the folded or unfolded display 140, or capable of assisting in the determining of the folding/unfolding angle, such as a gyroscope, an accelerometer, an angle sensor in a foldable area of the display 140, an electrostatic touch sensor, and/or the like.

The angle sensor in the foldable area of the display 140 may be connected to a hinge or may be included in the hinge. In addition, the electrostatic touch sensor may be included as a component of the display 140.

As used herein, the expression “folding/unfolding (or foldable/unfoldable)” may indicate an operation or state of folding or unfolding the display 140.

The processing unit 110 may detect the unfolded angle of the display 140 based on at least some of the sensors equipped in the device 100 as described above.

The processing unit 110 may detect the unfolding angle (or unfolded state) of the display 140, and based on the determined unfolding angle, may display a graphical interface (e.g., a preset or predetermined graphical interface) corresponding to the determined unfolding angle in a suitable display area (e.g., a specific or predetermined display area) of the display 140.

In addition, the processing unit 110 may call (or execute) a function (e.g., a preset or predetermined function) based on a user input obtained based on the display 140, and/or may display a graphical interface of the called function on the display 140.

As used herein, the function may refer to a program. For convenience of illustration, the terms function and program having the same meaning may be separately used.

According to an embodiment, the processing of the control commands may be performed by the processing unit 110 based on at least a portion of a database provided free of charge or for a fee in an external device connected to the device 100.

The operation of the device 100 is performed based on data processing and device control of the processing unit 110, and the processing unit 110 may also perform other functions designated on the basis of the control commands received through an input/output unit (e.g., an input/output device) and/or the communication unit 130 of the device 100.

Further, in processing data acquired through the communication unit 130, the processing unit 110 may process the data based on an identified user. For example, the processing unit 110 may identify a user by using user information received from a user device connected to the device 100 through the communication unit 130, and/or user information acquired through an input unit or device (e.g., an input/output unit or device) connected to the device 100, and perform an operation according to the control command input by the identified user.

The storage unit 120 may store various data processed by at least one component (e.g., the processing unit 110 or the communication unit 130) of the device 100. The data may include, for example, a program for processing of the control command, data processed through the program, and/or input data and output data related thereto.

For processing the control commands, the storage unit 120 may include an artificial neural network algorithm, a blockchain algorithm, a deep learning algorithm, a regression analysis algorithm, and/or an artificial intelligence algorithm, based on at least some of mechanisms, operators, language models, and/or big data related thereto.

The storage unit 120 may include the interface control data 121 as described above. In more detail, the interface control data 121 may include at least some control commands for displaying content (e.g., image, graphical interface, etc.) on the display 140.

In addition, the interface control data 121 may include a control command for dividing the display area of the display 140 into a plurality of display areas, and displaying graphical interfaces in the plurality of divided display areas.

The storage unit 120 may include data for confirming and processing the control and operations (e.g., the predetermined control and operations) through signals received from each of the devices included in the input/output unit and/or through the communication unit 130.

The operations performed in relation to the storage unit 120 are processed by the processing unit 110, and data for processing the related operations, data in process, processed data, preset data, and the like may be stored in the storage unit 120 as a database.

The data stored in the storage unit 120 may be changed, modified, deleted, and/or generated as new data by the processing unit 110 based on the user input of the identified user.

The storage unit 120 may store device setting information of the device 100. The device setting information may be setting information on the device 100 and at least some of functions and services provided by the device 100.

The storage unit 120 may store user information (e.g., user account) for at least one user. As the user information, at least some piece of information among user identification information (e.g., identification, ID), password, and/or user-customized setting information may be stored. The user-customized setting information is setting information on at least some of control authority and/or the functions of the device 100, and may be set and stored according to the administrator input.

At least some piece of the user information may be stored as data for the operation of the interface control data 121.

The storage unit 120 may include a volatile memory, a non-volatile memory, and/or a computer-readable recording medium. In this case, the computer-readable recording medium may store a computer program for performing the described operations according to embodiments of the present disclosure by the device 100.

The communication unit 130 may support an establishment of a wired communication channel and/or an establishment of a wireless communication channel between the device 100 and at least one other device (e.g., the user device or an administrator device capable of controlling the device 100), and may perform communication through the established communication channel.

The communication unit 130 may perform various suitable operations, such as modulation/demodulation, encryption/decryption, and/or the like, during the communication, as would be known to those having ordinary skill in the art.

The communication unit 130 is operated dependently on, or independently from, the processing unit 110, and may include one or more communication processors to support wireless communication and/or wired communication.

According to an embodiment, when supporting the wireless communication, the communication unit 130 may include at least some communication modules of wireless communication modules, for example, such as a cellular communication module, a near field communication module, and/or a global navigation satellite system (GNSS) communication module.

When supporting the wired communication, the communication unit 130 may include at least some communication modules of wired communication modules, for example, a local area network (LAN) communication module, a power line communication module, a controller area network (CAN) communication module, and/or a serial peripheral interface (SPI) communication module.

In more detail, the communication unit 130 may communicate with the external device by wired and/or wireless through near field communication networks, such as Bluetooth, Bluetooth Low Energy (BLE), WiFi, WiFi direct, infrared data association (IrDA), ZigBee, UWB, and/or radio frequency (RF), and/or far field communication networks, such as a cellular network, the Internet, or a computer network (e.g., LAN or WAN).

Various suitable kinds of communication modules that form the communication unit 130 may be integrated into one component (e.g., a single chip), or may be implemented as a plurality of separate components (e.g., a plurality of chips).

The communication unit 130 may perform communication with the external device of the device 100 as described above. However, the present disclosure is not limited thereto, and the communication unit 130 may perform communications with the storage unit 120 and/or at least some of the various components inside the device 100.

The display 140 may be formed of a flexible display configured to be folded/unfolded. In more detail, the display 140 may be a flexible display formed of one touch screen panel.

Referring to FIGS. 2 and 3, the device 100 having the display 140 formed therein may include a first body part 201 and a second body part 203, which may be folded/unfolded based on a hinge 211.

The display 140 may be formed on at least one surface of the first body part 201 or the second body part 203, which may be unfolded by the hinge 211.

According to an embodiment, the display 140 may divide a foldable display area (e.g., into a first display area 141 and a second display area 143) about a foldable area 311 formed by the hinge 211.

The first display area 141 and the second display area 143 may be folded or unfolded at a suitable angle based on the operation of the hinge 211.

In addition, the display 140 may include a third display area 145 as an external display area, which extends from the second display area 143 to the outside (or in other words, extends toward the second display area 143 from the outside), and is bent at a suitable angle (e.g., a predetermined angle) in a lateral direction of the second body part 203.

In other words, the first display area 141 and the second display area 143 may be formed on a first plane of the display 140 to be folded or unfolded based on the operation of the hinge 211, and the third display area 145 may be formed on a second plane extending from one end of the first plane (e.g., extending from one end of the second display area 143) at a suitable angle (e.g., a predetermined angle) with respect to the first plane.

The first display area 141, the second display area 143, and the third display area 145 may display different content (e.g., different image, different graphical interface, etc.) from each other by the processing unit 110.

The first display area 141 and the second display area 143 may be areas on the display 140 (or on a touch screen) that may be determined (e.g., that may be set) based on the foldable area 311 where the display 140 may be folded/unfolded. Similarly, the second display area 143 and the third display area 145 may be areas on the display 140 (or on the touch screen) that may be determined based on a bent area (e.g., a bent area 313) where the display 140 is bent.

Referring to FIGS. 2 and 3, the third display area 145 may display the graphical interface externally, even when the first body part 201 and the second body part 203 are completely folded so that the first display area 141 and the second display area 143 face each other.

The display 140 includes the touch screen (e.g., a touch screen panel) as described above, and may perform an operation of the input unit that receives the user input.

Two or more of the display areas of the plurality of display areas formed in the display 140 may be operated as one display area. According to an embodiment, the first display area 141 and the second display area 143 may be operated as one display area.

For example, when displaying an image (e.g., a still image or a moving image) on the display 140, the image may be displayed using the first display area 141 and the second display area 143 as one display area.

The photographing unit 150 may include at least one camera. Referring to FIG. 2, the photographing unit 150 may be formed in an outer surface of the second body part 203 to be exposed to the outside. However, the present disclosure is not limited thereto, and the photographing unit 150 may be formed in at least one surface of the first body part 201 or the second body part 203 so as to include the photographing unit 150.

In addition, the photographing unit 150 may be formed together with the display 140. For example, the photographing unit 150 may be formed in an under-display camera (UDC) manner.

In addition, in some embodiments, the device 100 may further include the input/output unit. The input/output unit may include an input unit (e.g., an input device) and an output unit (e.g., an output device).

The input/output unit may include at least some of a microphone, a keyboard, a mouse, or the like as the input unit to input data, and a speaker, a driving unit (e.g., a driver), or the like as the output unit to output data.

According to various embodiments of the present disclosure, the device 100 or the user device may include at least some of functions of all information and communication devices including a mobile communication terminal, a multimedia terminal, a wired terminal, a fixed terminal, an internet protocol (IP) terminal, and the like.

The device 100 may control command processing, and may include at least some functions of a workstation or a large-capacity database, or may be connected to at least some of the workstation or the large-capacity database through communication.

As the device 100 or the user device connected to the device 100, a mobile phone, a personal computer (PC), a portable multimedia player (PMP), a mobile internet device (MID), a smartphone, a tablet PC, a phablet PC, a laptop computer, and the like may be provided as some examples of an electronic device.

According to various embodiments of the present disclosure, the user device may be connected to the device 100, and may communicate therewith. For example, the user device may be a smartphone of the user, which is connected to the device 100 through wireless communication, and transmits the user input so that the device 100 performs the operation according to embodiments of the present disclosure.

The user device may be connected to the device 100 through at least one program installed therein, or may be connected to the device 100 through at least one web page accessed online by the device 100.

As such, in some embodiments, the device 100 may include at least some of the functions of a server and/or a terminal.

The server may be an entity that exists on a network, and performs roles of a web server, a database server, and/or an application server. According to an embodiment, the server may provide various suitable services to the device 100 and/or the user device based on processing of the device 100.

Hereinafter, a method of controlling the operation of the divided display areas in the display 140 of the device 100 will be described in more detail with reference to some of the other drawings.

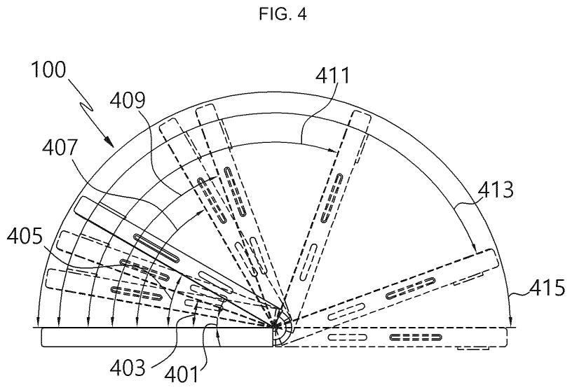

FIG. 4 is a view schematically illustrating a state in which the display is being folded/unfolded at various angles in the device according to an embodiment of the present disclosure.

FIG. 4 illustrates a state in which the first display area 141 and the second display area 143 are unfolded at a first angle 401, a second angle 403, a third angle 405, a fourth angle 407, a fifth angle 409, a sixth angle 411, a seventh angle 413, and an eighth angle 415.

The first angle 401, the second angle 403, the third angle 405, the fourth angle 407, and the fifth angle 409 may be angles that are less than 90 degrees. In addition, the sixth angle 411, the seventh angle 413, and the eighth angle 415 may be angles that are 90 degrees or more and 180 degrees or less.

However, the present disclosure is not limited thereto, and the eighth angle 415 indicating a maximum unfoldable angle between the first display area 141 and the second display area 143 may be an angle exceeding 180 degrees.

As used herein, the first angle 401 may be a specific angle within an Angular Range 1, the second angle 403 may be a specific angle within an Angular Range 2, the third angle 405 may be a specific angle within an Angular Range 3, the fourth angle 407 may be a specific angle within an Angular Range 4, the fifth angle 409 may be a specific angle within an Angular Range 5, the sixth angle 411 may be a specific angle within an Angular Range 6, the seventh angle 413 may be a specific angle within an Angular Range 7, and the eighth angle 415 may be a specific angle within an Angular Range 8.

The maximum value of the Angular Range 1 may be less than the minimum value of the Angular Range 2. The maximum value of the Angular Range 2 may be less than the minimum value of the Angular Range 3. The maximum value of the Angular Range 3 may be less than the minimum value of the Angular Range 4. The maximum value of the Angular Range 4 may be less than the minimum value of the Angular Range 5. The maximum value of the Angular Range 5 may be less than the minimum value of the Angular Range 6. The maximum value of the Angular Range 6 may be less than the minimum value of the Angular Range 7. The maximum value of the Angular Range 7 may be less than the minimum value of the Angular Range 8.

In addition, although FIG. 4 illustrates the Angular Range 1, the Angular Range 2, the Angular Range 3, the Angular Range 4, the Angular Range 5, the Angular Range 6, the Angular Range 7, and the Angular Range 8, these ranges may illustrate various embodiments of the present disclosure, and thus, at least one angular range having values that do not overlap with the others may be further included between the Angular Range 1 and the Angular Range 2, between the Angular Range 2 and the Angular Range 3, between the Angular Range 3 and the Angular Range 4, between the Angular Range 4 and the Angular Range 5, between the Angular Range 5 and the Angular Range 6, between the Angular Range 6 and the Angular Range 7, or between the Angular Range 7 and the Angular Range 8.

Referring to FIG. 4, the first display area 141 and the second display area 143 of the display 140 may maintain or substantially maintain an angle manipulated based on the manipulation of a user of the device 100.

As such, the hinge 211 may be connected to the first body part 201 and the second body part 203, and may maintain or substantially maintain the angle manipulated by the user. The angle between the first display area 141 and the second display area 143 of the display 140 may be fixed (e.g., may be maintained or substantially maintained) according to the manipulation of the user, as described above.

The processing unit 110 may detect the angle between the first display area 141 and the second display area 143. The processing unit 110 may detect the angle between the first display area 141 and the second display area 143, and when determined that the detected angle is within a suitable angular range (e.g., a specific or predetermined angular range), the processing unit 110 may call a function corresponding to the angular range (e.g., the specific or predetermined angular range), and display a graphical interface (e.g., a preset or predetermined graphical interface) for the called function in the third display area 145.

The processing unit 110 may perform a corresponding function for the displayed graphical interface based on the user input acquired through the third display area 145, and/or the angle between the first display area 141 and the second display area 143 and an angle change.

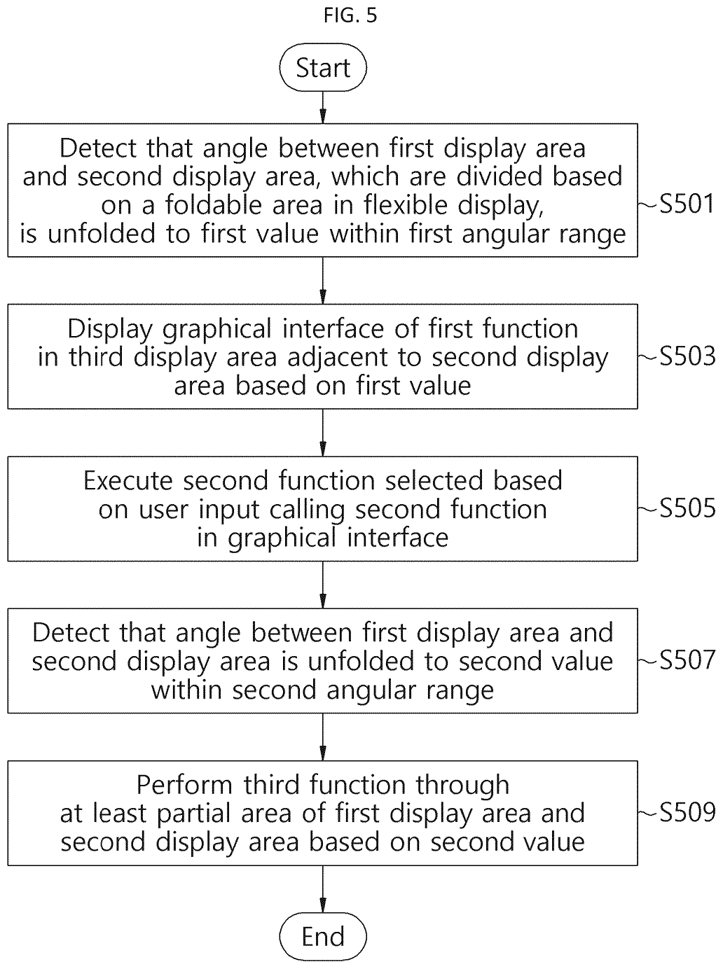

Hereinafter, an operation for displaying a graphical interface and/or performing a specific function in the third display area 145 based on the angle between the first display area 141 and the second display area 143 will be described in more detail with reference to FIG. 5.

FIG. 5 is a flowchart illustrating an operation for controlling graphical interfaces to be displayed in divided display areas of a flexible display in the device according to an embodiment of the present disclosure.

Referring to FIG. 5, the method/operation may start, and the processing unit 110 may detect that an angle between the first display area 141 and the second display area 143, which are divided by a foldable area in the display 140 of the device 100, is unfolded to a first value within a first angular range (S501). The processing unit 110 may display a graphical interface (e.g., a preset or predetermined graphical interface) of a first function in a third display area adjacent to the second display area based on the first value (S503). The processing unit 110 may execute a second function selected based on a user input calling the second function in the graphical interface (S505). The processing unit 110 may detect that the angle between the first display area 141 and the second display area 143 is unfolded to a second value within a second angular range (S507). The processing unit 110 may perform a third function (e.g., a preset or predetermined third function) through at least a partial area of the first display area and the second display area based on the second value (S509), and the method/operation may end.

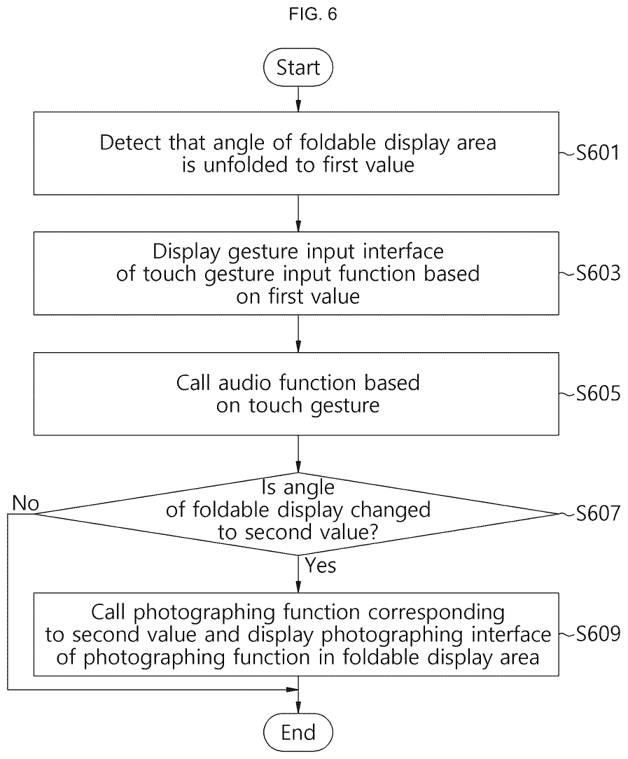

In this regard, some of the method/operation according to a first embodiment may be described in more detail hereinafter with reference to FIGS. 6 to 11.

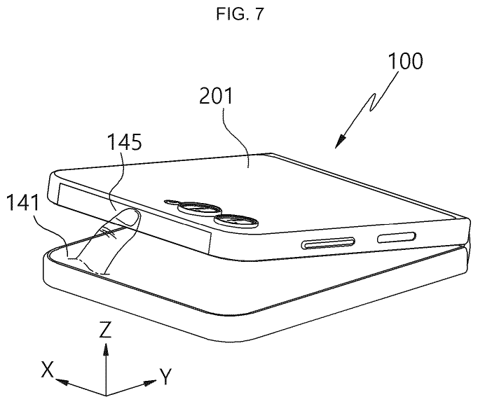

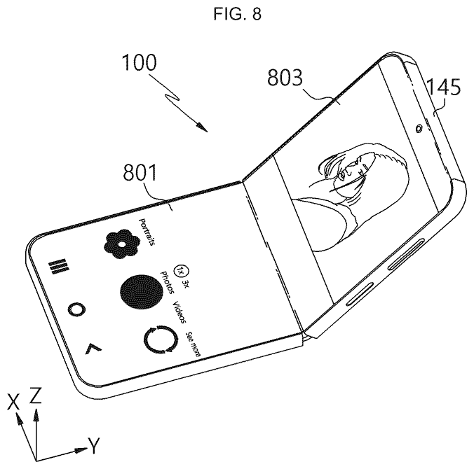

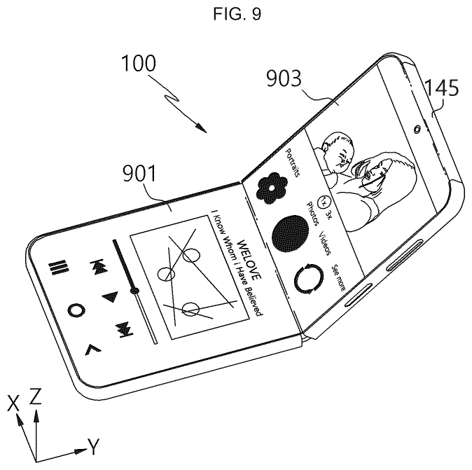

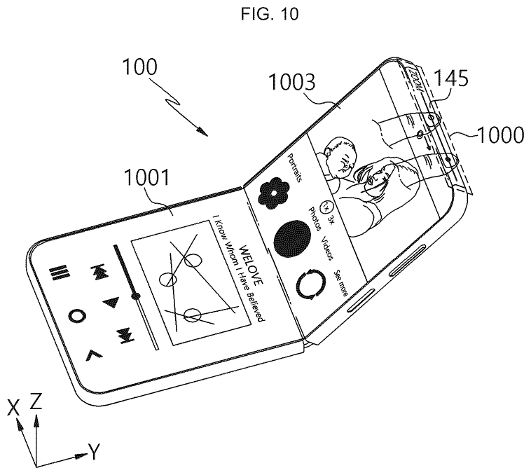

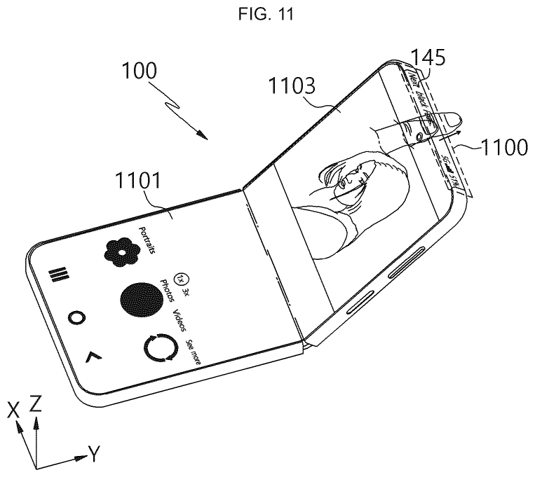

FIG. 6 is a flowchart illustrating an operation for controlling graphical interfaces to be displayed in the divided display areas of the flexible display in the device according to an embodiment of the present disclosure. FIG. 7 is a perspective view illustrating an operation for obtaining a user input through an external display area of the flexible display in the device according to an embodiment of the present disclosure. FIGS. 8 and 9 are perspective views illustrating operations for displaying graphical interfaces of functions executed based on unfolding of the foldable display area in the device according to some embodiments of the present disclosure. FIGS. 10 and 11 are perspective views illustrating operations for controlling detailed functions of the functions executed based on unfolding of the foldable display area in the device using an external display area according to some embodiments of the present disclosure.

Referring to FIG. 6, the method/operation may start, and the processing unit 110 may detect that the angle between the first display area 141 and the second display area 143, which are divided by a foldable area in the flexible display, is unfolded to a first value within a first angular range (S601).

According to an embodiment, the processing unit 110 may detect that the first display area 141 and the second display area 143 are unfolded to the first value (e.g., the first angle 401) within the first angular range (e.g., the Angular Range 1) based on a manipulation of the user.

The first value based on the manipulation of the user (e.g., the first angle 401) may be, for example, 10 degrees.

In addition, the Angular Range 1 may be a state in which the minimum value is greater than a minimum angle (e.g., 0 degrees) at which the angle between the first display area 141 and the second display area 143 can be unfolded. For example, the Angular Range 1 may be an angular range (e.g., a specific or predetermined angular range) that is greater than 0 degrees and less than 90 degrees.

In more detail, the Angular Range 1 may be defined as a range greater than 0 degrees and less than 15 degrees. However, the present disclosure is not limited thereto, and the Angular Range 1 may be variously changed as needed or desired depending on the setting.

At least some of the operations in S601 may be operations performed in S501 described above with reference to FIG. 5.

The processing unit 110 may call a touch gesture input function (e.g., a preset touch gesture input function, or a first function) corresponding to the first angular range including the first value, and may display a gesture input interface (e.g., a graphical interface) of the touch gesture input function in the third display area 145 (S603).

According to an embodiment, the processing unit 110 may call the touch gesture input function (e.g., the first function) to acquire a touch gesture of the user corresponding to the Angular Range 1.

The processing unit 110 may display a gesture input interface to call the touch gesture input function, and may acquire a touch gesture according to the user input as a graphical interface in the third display area 145.

In more detail, the displaying of the gesture input interface in the third display area 145 may be to drive the third display area 145 as a touch pad for acquiring the touch gesture of the user.

However, with respect to the function corresponding to the Angular Range 1 (e.g., the first function), it is not limited to performing the operation for calling the touch gesture input function and displaying the gesture input interface corresponding thereto, and may be variously modified as needed or desired to perform various suitable functions.

At least some of the operations of S603 may be operations performed in S503 described above with reference to FIG. 5.

The processing unit 110 may call an audio function (e.g., a second function) based on the touch gesture (S605), which may be acquired through the third display area 145.

According to an embodiment, as described above with respect to S603, the graphical interface to be displayed in the third display area 145 may be the gesture input interface to acquire a touch gesture based on the user input.

In S605, the processing unit 110 may call a function corresponding to the user input (e.g., the touch gesture) acquired through the gesture input interface while the gesture input interface is displayed in the third display area 145.

For example, when determining a touch gesture for drawing a specific clef (e.g., a specific note, or a specific rest) such as a treble clef through the third display area 145 where the gesture input interface is displayed, the processing unit 110 may call the audio function corresponding to the specific clef (e.g., the specific note, or the specific rest).

The audio function may include at least one service (e.g., at least one function) for playing (e.g., for outputting) audio, such as a media player, an audio player, an audio streaming service, a media streaming service, and/or the like.

The processing unit 110 may play specific music (e.g., a specific playlist) of the audio function when the audio function is called. As such, the storage unit 120 may play the specific music (e.g., the specific playlist) when the audio function is called.

As described above, calling the audio function corresponding to the touch gesture has been described, but the function to call corresponding to the touch gesture may be variously modified as needed or desired depending on the setting.

At least some of the operations of S605 may be operations performed in S505 described above with reference to FIG. 5.

The processing unit 110 may detect that the angle between the first display area 141 and the second display area 143 is changed to a second value within a second angular range (S607).

According to an embodiment, the processing unit 110 may detect that the angle between the first display area 141 and the second display area 143 is unfolded to the second value (e.g., the sixth angle 411) in the second angular range (e.g., the Angular Range 6).

The second value based on the manipulation of the user (e.g., the sixth angle 411) may be, for example, 110 degrees.

The Angular Range 6 may be a state in which the angle between the first display area 141 and the second display area 143 is 90 degrees or more. In more detail, the Angular Range 6 may be defined as a range of 90 degrees or more and less than 120 degrees.

However, the present disclosure is not limited thereto, and the Angular Range 6 may be variously modified as needed or desired depending on the setting. For example, the Angular Range 6 may also include 90 degrees.

As described above, when it is detected that the angle between the first display area 141 and the second display area 143 is changed to the second value (e.g., a value of 90 degrees or more) within the second angular range (e.g., the angular range including the minimum value and the maximum value of 90 degrees or more), the processing unit 110 may perform S609 (e.g., YES at S607).

On the other hand, if (e.g., when) the angle between the first display area 141 and the second display area 143 is not changed, the processing unit 110 may terminate the method/operation of FIG. 6 (e.g., NO at S607), or in other words, the method/operation may end.

At least some of the operations of S607 may be operations performed in S507 described above with reference to FIG. 5.

In S609, the processing unit 110 may call a photographing function (e.g., a preset or predetermined photographing function, or a third function) corresponding to the second angular range, and may display a photographing interface (e.g., a graphical interface) of the photographing function in at least a partial area of the first display area 141 and the second display area 143.

According to an embodiment, the processing unit 110 may execute a photographing function (e.g., a third function) corresponding to the second angular range (e.g., the Angular Range 6). The processing unit 110 may display a graphical interface of the executed photographing function in at least a partial area of the first display area 141 and the second display area 143.

For example, the processing unit 110 may display photographing interfaces 801 and 803 for the photographing function in the first display area 141 and the second display area 143, as shown in FIG. 8.

The processing unit 110 may maintain the execution of the audio function (e.g., the second function), while displaying the photographing function (e.g., the third function) in the first display area 141 and/or the second display area 143. For example, the processing unit 110 may process the audio function (e.g., the second function) to be operated in the background. According to an embodiment, the processing unit 110 may continue playing the music during reproduction without stopping.

According to another example, as shown in FIG. 9, when an audio playback interface 901 based on the audio function is displayed in the first display area 141 (or the second display area 143), the processing unit 110 may display a graphical interface 903 of the photographing function in the second display area 143 (or the first display area 141).

In this case, when an audio playback interface 1001 based on the audio function is being displayed in the entire first display area 141 and the second display area 143, the processing unit 110 may reduce the audio playback interface 1001, and may display it in the first display area (or the second display area 143), and may display a photographing interface 1003 of the photographing function in the second display area 143 (or the first display area 141).

As such, the storage unit 120 may perform the photographing function when the angle between the first display area 141 and the second display area 143 is positioned at a suitable angle (e.g., a specific or predetermined angle) within the second angular range (e.g., the Angular Range 6).

In more detail, the storage unit 120 may execute the photographing function when the angle between the first display area 141 and the second display area 143 is positioned at a suitable angle (e.g., a specific or predetermined angle) within the second angular range (e.g., the Angular Range 6) while the audio function is executed in the device 100.

According to various embodiments, the processing unit 110 may be driven to control at least a partial detailed function of the photographing function through the third display area 145, while the photographing interface of the photographing function (e.g., the third function) is displayed in the first display area 141 and/or the second display area 143.

For example, the processing unit 110 may drive the third display area 145 as a touch pad that controls the zoom of the photographing function (e.g., the third function). In this case, when acquiring a touch gesture of the user through the third display area 145, the processing unit 110 may display a graphical interface 1000 of the zoom function under control in the third display area 145, as shown in FIG. 10.

However, the present disclosure is not limited thereto, and the processing unit 110 may be driven to control at least a partial detailed function of the audio function (e.g., the second function) or the photographing function (e.g., the third function) through the third display area 145 depending on the setting.

For example, the processing unit 110 may drive the third display area 145 as a touch pad that controls the volume or the track of the audio function (e.g., the second function).

In more detail, the processing unit 110 may drive the third display area 145 as the touch pad that controls the volume and/or the track of the audio function (e.g., the third function).

According to an embodiment, the processing unit 110 may control the volume or the track based on the touch gesture, such as a left drag or a right drag in a longitudinal direction (e.g., a direction having a longer length in the third display area 145), or an upward drag or a downward drag in a width direction (e.g., a direction having a shorter length in the third display area 145), which may be acquired through the third display area 145.

In this case, when acquiring the touch gesture of the user through the third display area 145, the processing unit 110 may display a graphical interface 1100 of the volume control or the track control function under control in the third display area 145.

According to an embodiment, the graphical interface 1100 of the track control function corresponding to the track control gesture acquired for the third display area 145 may be displayed in the third display area 145, as shown in FIG. 11.

In this case, the processing unit 110 may control a detailed operation of the audio function (e.g., the second function) being operated in the background through the third display area 145, even when the photographing interfaces 1101 and 1103 are displayed through the first display area 141 and the second display area 143.

As such, the volume of the audio function (e.g., the second function) may be controlled through the third display area 145, while the audio function (e.g., the second function) is executed in the background.

In addition, the processing unit 110 may control the volume or the track of the audio function (e.g., the second function) based on the touch gesture input through the first display area 141 and/or the second display area 143.

For example, the processing unit 110 may control (e.g., may mute) the volume of the audio function (e.g., the second function) through the upward drag input that is input through the first display area 141 and/or the second display area 143, and may control (e.g., may change to the next track) the track of the audio function (e.g., the second function) through the downward drag input.

As another example, the processing unit 110 may control the volume of the audio function (e.g., the second function) through the upward/downward drag input that is input through the first display area 141 and/or the second display area 143, and may also control the track of the audio function (e.g., the second function) through the left/right drag input.

According to various embodiments, the processing unit 110 may acquire at least one image (e.g., a still image or a moving image) to be captured based on the photographing function (e.g., the third function) executed through S609 described above and the user input.

In this case, the processing unit 110 may display the captured image (e.g., the still image or the moving image) as an image (e.g., a thumb-nail image or moving image) of the music (e.g., a playlist) during reproduction.

In some embodiments, the processing unit 110 may display a message for determining whether to display the captured image (e.g., the still image or the moving image) as an image (e.g., the thumb-nail image or the moving image) of the music (e.g., the playlist) during reproduction on the graphical interface (e.g., an audio playback interface) of the photographing function, and based on the user input thereto, may or may not display the captured image as the image of the music during reproduction.

At least some of the operations in S609 may be operations performed in S509 described above with reference to FIG. 5.

When the execution S609 is completed, the processing unit 110 may terminate the method/operation of FIG. 6, or in other words, the method/operation of FIG. 6 may end.

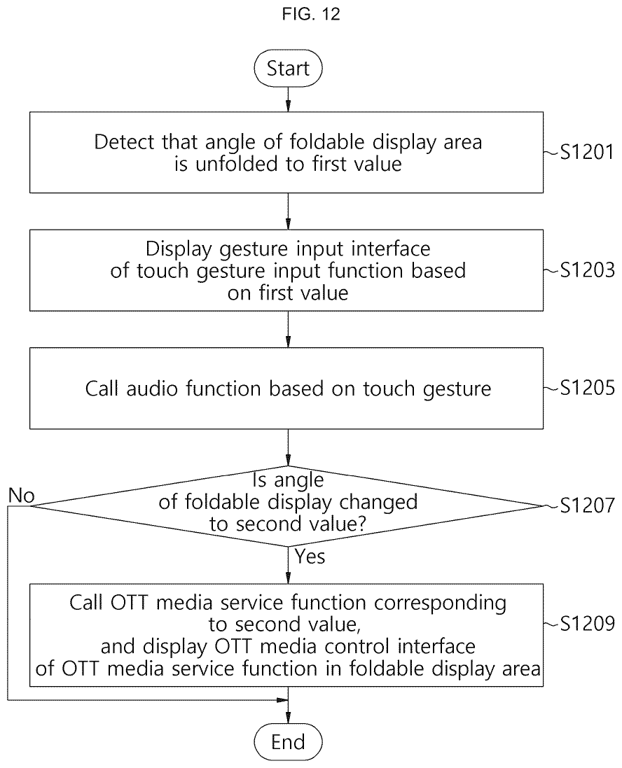

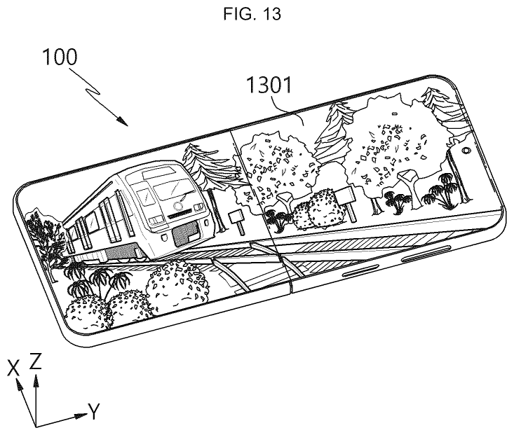

Hereinafter, some of the method/operation according to a second embodiment may be described in more detail hereinafter with reference to FIGS. 12 and 13.

FIG. 12 is a flowchart illustrating an operation for controlling graphical interfaces to be displayed in the divided display areas of the flexible display in the device according to an embodiment of the present disclosure. FIG. 13 is a perspective view illustrating an operation for displaying a graphical interface of a function executed based on unfolding of the foldable display area in the device according to an embodiment.

According to an embodiment, operations S1201 to S1205 of FIG. 12 may be performed the same or substantially the same as (or similar to) the operations S601 to S605 of the first embodiment described above. Accordingly, redundant description of the operations S1201 to S1205 of the second embodiment may not be repeated.

In S1207, the processing unit 110 may detect whether or not the angle between the first display area 141 and the second display area 143 is changed to a second value within a second angular range.

According to an embodiment, the processing unit 110 may detect that the angle between the first display area 141 and the second display area 143 is unfolded to the second value (e.g., the eighth angle 415) in the second angular range (e.g., the Angular Range 8) (e.g., YES at S1207).

The second value based on the manipulation of the user (e.g., the eighth angle 415) may be, for example, 180 degrees.

The Angular Range 8 may be a state in which the angle between the first display area 141 and the second display area 143 is a value of 180 degrees or less. In more detail, the Angular Range 8 may be defined as a range greater than the maximum value of the Angular Range 7 and 180 degrees or less. However, the present disclosure is not limited thereto, and the Angular Range 8 may be variously modified as needed or desired depending on the setting.

As described above, when it is detected that the angle between the first display area 141 and the second display area 143 is changed to the second value (e.g., the value of 90 degrees or more) within the second angular range (e.g., the angular range including the minimum value and the maximum value of 90 degrees or more) (e.g., YES at S1207), the processing unit 110 may perform S1209.

On the other hand, if (e.g., when) the angle between the first display area 141 and the second display area 143 is not changed (e.g., NO at S1207), the processing unit 110 may terminate the procedures of the second embodiment illustrated in FIG. 12, or in other words, the method/operation may end.

At least some of the operations of S1207 may be operations performed in S507 described above with reference to FIG. 5.

In S1209, the processing unit 110 may call an over-the top (OTT) media service function (e.g., a preset or predetermined OTT media service function, or a third function) corresponding to the second angular range, and may display an OTT media control interface (e.g., a menu interface, a video interface, and/or the like) of the OTT media service function as a graphical interface in the first display area 141 and the second display area 143, as shown in FIG. 13.

In this case, the storage unit 120 may perform the OTT media service function when the angle between the first display area 141 and the second display area 143 is positioned at an angle (e.g., a specific or predetermined angle) within the second angular range (e.g., the Angular Range 8).

In more detail, the storage unit 120 may perform the OTT media service function when the angle between the first display area 141 and the second display area 143 is positioned at the angle within the second angular range (e.g., the Angular Range 8) while the audio function is executed in the device 100.

However, the present disclosure is not limited thereto, and in a state where the angle between the first display area 141 and the second display area 143 is an angle (e.g., a specific or predetermined angle) within the first angular range and a specific function (e.g., audio function) is called and executed based on the fourth graphical interface corresponding to the first angular range, the storage unit 120 may perform the OTT media service function when the angle between the first display area 141 and the second display area 143 is positioned at an angle (e.g., a specific or predetermined angle) within the fifth angular range.

According to various embodiments, the processing unit 110 may be driven to control at least a partial detailed function of the OTT media service function (e.g., the third function) through the third display area 145, while the media control interface of the OTT media service function is displayed in the first display area 141 and/or the second display area 143.

For example, the processing unit 110 may drive the third display area 145 as a touch pad that controls the volume of the OTT media service function (e.g., the third function). In this case, when acquiring a touch gesture of the user through the third display area 145, the processing unit 110 may display the graphical interface 1000 of the zoom function under control in the third display area 145.

While the OTT media service function (e.g., the third function) is executed, the operation for controlling the volume of the image being output to the first display area 141 and the second display area 143 using the third display area 145 may be performed by the method that is the same or substantially the same as (or similar to) that is the same or substantially the same as (or similar to) the operation for controlling the volume of the audio function described above with reference to FIG. 10.

As such, the volume of the OTT media service function (e.g., the third function) may be controlled through the third display area 145, while the OTT media service function is executed.

However, the present disclosure is not limited thereto, and the third display area 145 may control various suitable detailed functions of the third function being executed, such as controlling the brightness of the OTT media service function through the third display area 145 while the OTT media service function is executed.

At least some of the operations of S1209 may be operations performed in S509 described above with reference to FIG. 5.

When the execution of S1209 is completed, the processing unit 110 may terminate the procedures of the second embodiment of FIG. 12, or in other words, the method/operation may end.

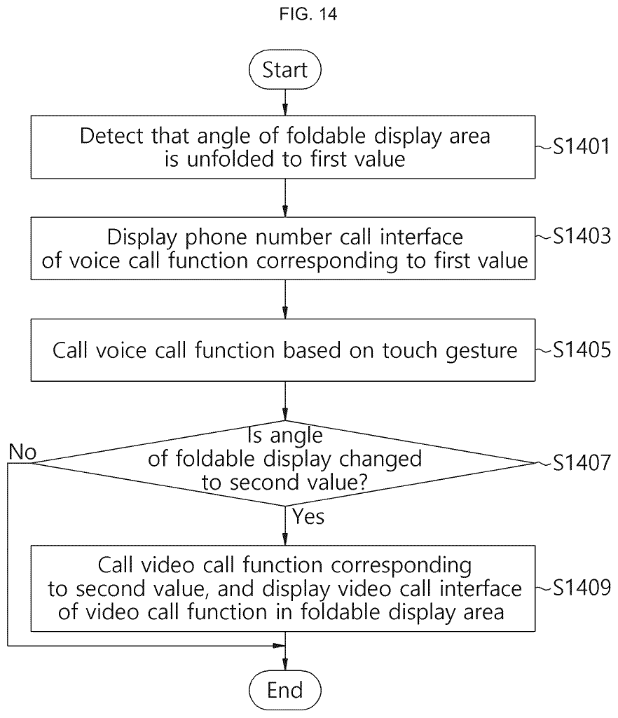

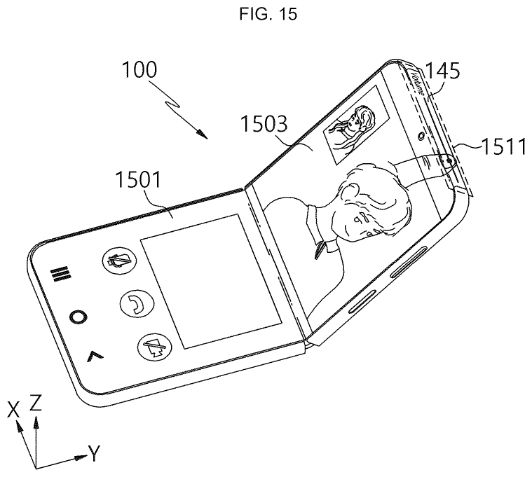

Hereinafter, some of the method/operation according to a third embodiment may be described in more detail hereinafter with reference to FIGS. 14 and 15.

FIG. 14 is a flowchart illustrating an operation for controlling graphical interfaces displayed in the divided display areas of the flexible display in the device according to an embodiment of the present disclosure. FIG. 15 is a perspective view illustrating an operation for displaying graphical interfaces of functions executed based on unfolding of the foldable display area in the device according to an embodiment of the present disclosure.

Referring to FIG. 14, the method/operation may start, and the processing unit 110 may detect that the angle between the first display area 141 and the second display area 143, which are divided by a foldable area in the flexible display, is unfolded to a first value within a first angular range (S1401).

According to an embodiment, the processing unit 110 may detect that the first display area 141 and the second display area 143 are unfolded to the first value (e.g., the first angle 401) within the first angular range (e.g., the Angular Range 1) based on a manipulation of the user.

The first value based on the manipulation of the user (e.g., the first angle 401) may be, for example, 10 degrees.

In addition, the Angular Range 1 may be a state in which the minimum value is greater than the minimum angle (e.g., 0 degrees) at which the angle between the first display area 141 and the second display area 143 can be unfolded. For example, the Angular Range 1 may be within the range greater than 0 degrees and less than 90 degrees.

In more detail, the Angular Range 1 may be defined as a range greater than 0 degrees and less than 15 degrees. However, the present disclosure is not limited thereto, and the Angular Range 1 may be variously changed as needed or desired depending on the setting.

At least some of the operations of S1401 may be operations performed in S501 described above with reference to FIG. 5.

In S1403, the processing unit 110 may call a voice call function (e.g., a preset or predetermined voice call function, or a first function) corresponding to the first angular range including the first value, and may display a phone number call interface (e.g., a graphical interface) of the voice call function in the third display area 145.

In an embodiment, the phone number call interface may be a gesture input interface to acquire a touch gesture of the user, and determine a phone number corresponding to the acquired touch gesture.

For example, the phone number call interface may call a phone number corresponding to the touch gesture, such as inputting a phone number through a touch gesture of drawing a number, or calling a specific phone number stored by the number of touches.

In more detail, the displaying of the phone number call interface in the third display area 145 may drive the third display area 145 as a touch pad for acquiring the touch gesture of the user.

However, the present disclosure is not limited thereto, and the processing unit 110 may display a keypad (or a dial pad) interface or a phone book interface as the phone number call interface in the third display area 145.

As described above, the processing unit 110 may call the voice call function corresponding to the first angular range. However, the present disclosure is not limited thereto, and in S603 of FIG. 6, S1403 may be performed by calling the touch gesture input function corresponding to the first angular range, and then calling the voice call function corresponding to the user input acquired through the third display area 145.

At least some of the operations of S1403 may be operations performed in S503 described above with reference to FIG. 5.

In S1405, the processing unit 110 may make a phone call (e.g., the second function) based on the touch gesture acquired through the third display area 145.

The making of the phone call may be a detailed function of the voice call function.

According to an embodiment, when acquiring a user input of touching a specific number of times (e.g., three times) through the phone number call interface displayed in the third display area 145, the processing unit 110 may make a phone call (e.g., the second function) to the phone number set to a speed dial number (e.g., Speed Dial Number 3) corresponding to the specific number of times (e.g., three times) of the user input.

According to another embodiment, when a phone number is input or selected through the keypad (or dial pad) interface or phone book interface displayed in the third display area, the processing unit 110 may make a phone call (e.g., the second function) to the corresponding phone number.

As described above, the processing unit 110 may perform the detailed functions of the first function as the second function.

At least some of the operations of S1405 may be operations performed in S505 described above with reference to FIG. 5.

In S1407, the processing unit 110 may detect that the angle between the first display area 141 and the second display area 143 is changed to a second value within a second angular range.

According to an embodiment, the processing unit 110 may detect that the angle between the first display area 141 and the second display area 143 is unfolded to the second value (e.g., the sixth angle 411) in the second angular range (e.g., the Angular Range 6).

The second value based on the manipulation of the user (e.g., the sixth angle 411) may be, for example, 110 degrees.

The Angular Range 6 may be a state in which the angle between the first display area 141 and the second display area 143 is 90 degrees or more. In more detail, the Angular Range 6 may be defined as a range of 90 degrees or more and less than 120 degrees.

However, the present disclosure is not limited thereto, and the Angular Range 6 may be variously changed as needed or desired depending on the setting. For example, the Angular Range 6 may also include 90 degrees.

As described above, when it is detected that the angle between the first display area 141 and the second display area 143 is changed to the second value (e.g., the value of 90 degrees or more) within the second angular range (e.g., the angular range of the minimum value and the maximum value of 90 degrees or more), the processing unit 110 may perform S1409.

On the other hand, if (e.g., when) the angle between the first display area 141 and the second display area 143 is not changed, the processing unit 110 may terminate the procedures of the embodiment in FIG. 14 (e.g., the method/operation may end).

At least some of the operations of S1407 may be operations performed in S507 described above with reference to FIG. 5.

In S1409, the processing unit 110 may call a video call function (e.g., a preset or predetermined video call function, or a third function) corresponding to the second angular range, and may display a video call interface (e.g., a graphical interface) of the video call function in at least a partial area of the first display area 141 and the second display area 143.

According to an embodiment, the processing unit 110 may execute a video call function to be called corresponding to the second angular range (the Angular Range 6).

The calling of the video call function (e.g., the third function) by the processing unit 110 may switch the currently performing voice call function (e.g., the second function) to the video call function (e.g., the third function).

The processing unit 110 may display video call interfaces 1501 and 1503 of the executed video call function in at least a partial area of the first display area 141 and the second display area 143.

For example, the processing unit 110 may display the video call interfaces 1501 and 1503 for the video call function in the first display area 141 and the second display area 143, as shown in FIG. 15.

As such, when the angle between the first display area 141 and the second display area 143 is positioned at an angle (e.g., a specific or predetermined angle) within the second angular range (e.g., the Angular Range 6) while making a phone call is executed in the device 100, the storage unit 120 may perform the video call function.

According to various embodiments, the processing unit 110 may be driven to control at least a partial detailed function of the video call function through the third display area 145, while the video call interface of the video call function (e.g., the third function) is displayed in the first display area 141 and/or the second display area 143.

For example, the processing unit 110 may drive the third display area 145 as a touch pad that controls the zoom in the image captured by a caller of the video call function (e.g., the third function). In this case, the processing unit 110 may control the zoom function of the video call by a method that is the same or substantially the same as (or similar to) the operation for controlling the zoom described above with reference to FIG. 10.

In addition, the processing unit 110 may control the volume of the video call function (e.g., the third function) or the filter of the image captured by the caller based on the touch gesture input through the first display area 141 and/or the second display area 143.

For example, the processing unit 110 may control the volume of the video call function (e.g., the third function) through the downward drag input through the first display area 141 and/or the second display area 143, and may change the filter (e.g., may change to the next filter) of the video call function (e.g., the third function) through the upward drag input.

As another example, the processing unit 110 may control the volume of the video call function (e.g., the third function) through the upward/downward drag input through the first display area 141 and/or the second display area 143, and may also change the filter of the video call function (e.g., the third function) through the left/right drag input.

However, the present disclosure is not limited thereto, and the processing unit 110 may control the volume of the video call function (e.g., the third function) through the left/right drag input through the first display area 141 and/or the second display area 143, and may also change the filter of the video call function (e.g., the third function) through the upward/downward drag input.

When acquiring a touch gesture (e.g., the drag in the left/right direction) for a volume control through the third display area 145, the processing unit 110 may display a volume control interface 1511 in the third display area 145.

In an embodiment, at least some of the operations of S1409 may be operations performed in S509 described above with reference to FIG. 5.

When the execution of S1409 is completed, the processing unit 110 may terminate the procedures of the third embodiment illustrated in FIG. 14 (e.g., the method/operation may end).

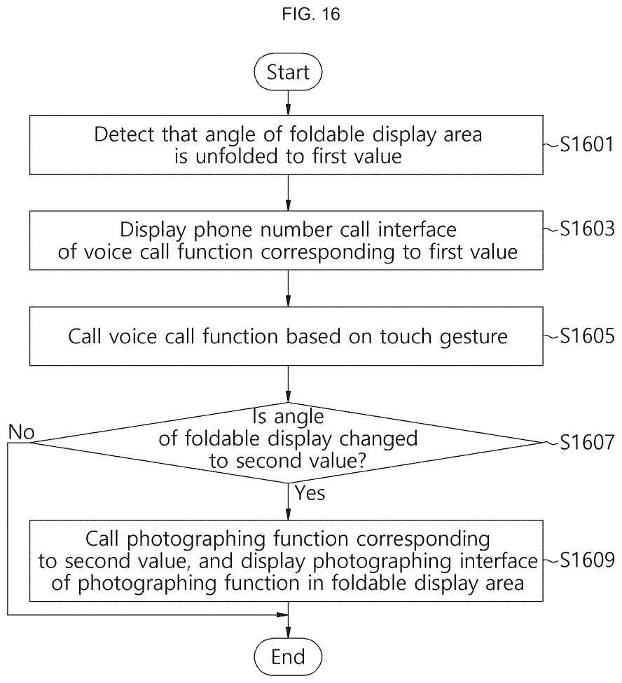

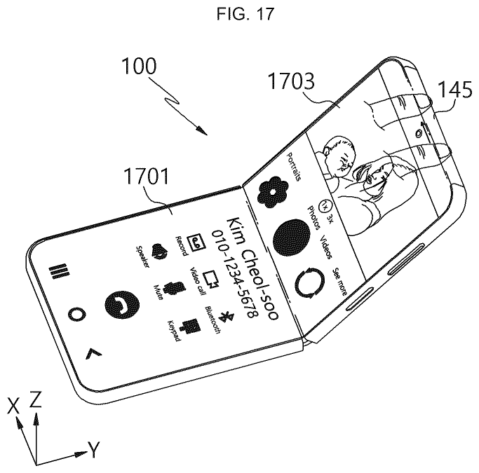

Hereinafter, some of the method/operation according to a fourth embodiment may be described in more detail hereinafter with reference to FIGS. 16 and 17.

FIG. 16 is a flowchart illustrating an operation for controlling graphical interfaces displayed in the divided display areas of the flexible display in the device according to an embodiment of the present disclosure. FIG. 17 is a perspective view illustrating an operation for displaying graphical interfaces of functions executed based on unfolding of the foldable display area in the device according to an embodiment of the present disclosure.

In the fourth embodiment, operations of S1601 to S1605 illustrated in FIG. 16 may be performed the same or substantially the same as (or similarly to) the operations of S1201 to S1205 of the third embodiment described above. Accordingly, redundant description thereof may not be repeated.

In S1607, the processing unit 110 may detect whether or not the angle between the first display area 141 and the second display area 143 is changed to a second value within a second angular range.

According to an embodiment, the processing unit 110 may detect that the angle between the first display area 141 and the second display area 143 is unfolded to the second value (e.g., the sixth angle 411) in the second angular range (e.g., the Angular Range 6).

The second value based on a manipulation of the user (e.g., the sixth angle 411) may be, for example, 110 degrees.

The Angular Range 6 may be a state in which the angle between the first display area 141 and the second display area 143 is 90 degrees or more. In more detail, the Angular Range 6 may be 90 degrees or more and less than 120 degrees.

However, the present disclosure is not limited thereto, and the Angular Range 6 may be variously changed as needed or desired depending on the setting.

For example, the Angular Range 6 may also include 120 degrees.

As described above, when it is detected that the angle between the first display area 141 and the second display area 143 is changed to the second value (e.g., the value of 90 degrees or more) within the second angular range (e.g., the angular range formed of the minimum value and the maximum value of 90 degrees or more), the processing unit 110 may perform S1609.

On the other hand, if (e.g., when) the angle between the first display area 141 and the second display area 143 is not changed, the processing unit 110 may terminate the procedures of the method/operation of FIG. 16 (e.g., the method/operation may end).

At least some of the operations in S1607 may be operations performed in S507 described above with reference to FIG. 5.

In S1609, the processing unit 110 may call a photographing function (e.g., a preset or predetermined photographing function, or a third function) corresponding to the second angular range, and may display a photographing interface (e.g., a graphical interface) of the photographing function in at least a partial area of the first display area 141 and the second display area 143.

According to an embodiment, the processing unit 110 may execute the photographing function (e.g., the third function) to call corresponding to the second angular range (e.g., the Angular Range 6). The processing unit 110 may display the graphical interface of the executed photographing function in at least a partial area of the first display area 141 and the second display area 143.

For example, the processing unit 110 may display photographing interfaces 801 and 803 for the photographing function in the first display area 141 and the second display area 143, as shown in FIG. 8.

The processing unit 110 may maintain the execution of the voice call function (e.g., the second function) while the photographing function (e.g., the third function) is displayed in the first display area 141 and/or the second display area 143. For example, the processing unit 110 may process the voice call function (e.g., the second function) to be operated in the background. According to an embodiment, the processing unit 110 may process to continue playing the call during reproduction without stopping.

According to another example, as shown in FIG. 17, when a voice call interface 1701 based on the voice call function is displayed in the first display area 141 (or the second display area 143), the processing unit 110 may display a graphical interface 1703 of the photographing function in the second display area 143 (or the first display area 141).

In this case, when the voice call interface 1701 based on the voice call function is being displayed in the entire first display area 141 and the second display area 143, the processing unit 110 may reduce the voice call interface 1701 and display it in the first display area (or the second display area 143), and may display the graphical interface 1703 of the photographing function in the second display area 143 (or the first display area 141).

As such, when the angle between the first display area 141 and the second display area 143 is positioned at an angle (e.g., a specific or predetermined angle) within the second angular range (e.g., the Angular Range 6), the storage unit 120 may perform the photographing function.

In more detail, when the angle between the first display area 141 and the second display area 143 is positioned at the specific angle within the second angular range (e.g., the Angular Range 6) while the voice call function is executed in the device 100, the storage unit 120 may perform the photographing function.

According to various embodiments, the processing unit 110 may be driven to control at least a partial detailed function of the photographing function through the third display area 145, while the photographing interface of the photographing function (e.g., the third function) is displayed in the first display area 141 and/or the second display area 143.

For example, the processing unit 110 may drive the third display area 145 as a touch pad that controls a photographing filter of the photographing function (e.g., the third function). In this case, when acquiring a touch gesture (e.g., a drag from right to left) of the user through the third display area 145, the processing unit 110 may change the photographing filter of the photographing function (e.g., the third function), as shown in FIG. 17.

However, the present disclosure is not limited thereto, and the processing unit 110 may be driven to control at least a partial detailed function of the voice call function (e.g., the second function) or the photographing function (e.g., the third function) through the third display area 145 depending on the setting.

For example, the processing unit 110 may drive the third display area 145 as a touch pad that controls the volume of the voice call function (e.g., the second function).

In more detail, the processing unit 110 may drive the third display area 145 as the touch pad that controls the volume of the voice call function (e.g., the third function).

According to an embodiment, the processing unit 110 may control the volume based on the touch gesture, such as an upward drag or downward drag in the width direction (e.g., a direction having a shorter length in the third display area 145), acquired through the third display area 145.

In this case, when acquiring the touch gesture for controlling the volume of a voice call through the third display area 145, the processing unit 110 may display a graphical interface of the volume control function (e.g., see the volume control interface 1511 of FIG. 15) in the third display area 145.

As such, the processing unit 110 may control the detailed operation of the voice call function (e.g., the second function) being operated in the background through the third display area 145, even while the photographing interfaces 1101 and 1103 are displayed through the first display area 141 and the second display area 143.

The volume of the voice call function (e.g., the second function) may be adjusted through the third display area 145, while the voice call function (e.g., the second function) is executed in the background.

In addition, the processing unit 110 may control the photographing filter of the photographing function (e.g., the third function) based on the touch gesture input through the first display area 141 and/or the second display area 143.

For example, the processing unit 110 may change the photographing filter of the photographing function (e.g., the third function) through the leftward drag input through the first display area 141 and/or the second display area 143.

According to various embodiments, the processing unit 110 may acquire at least one image (e.g., a still image or a moving image) captured based on the photographing function (e.g., the third function) executed based on S1609 and the user input.

In this case, the processing unit 110 may transmit the captured image to the call a counterpart. The processing unit 110 may display a message for determining whether or not the captured image will be transmitted to the called counterpart on the photographing interface (or voice call interface) being displayed through the first display area 141 and/or the second display area 143, and the captured image may be transmitted or not transmitted to the call counterpart based on the user input thereto.

At least some of the operations of S1609 may be operations performed in S509 described above with reference to FIG. 5.

When the execution of S1609 is completed, the processing unit 110 may terminate the method/process of the first embodiment described above with reference to FIG. 6 (e.g., the method/process may end).

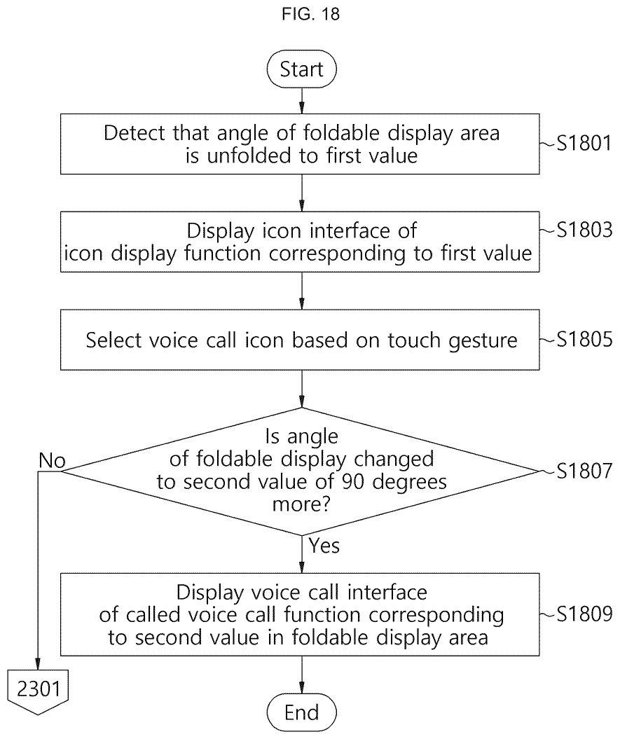

Hereinafter, some of the method/operation according to a fifth embodiment may be described in more detail hereinafter with reference to FIGS. 18 to 22.

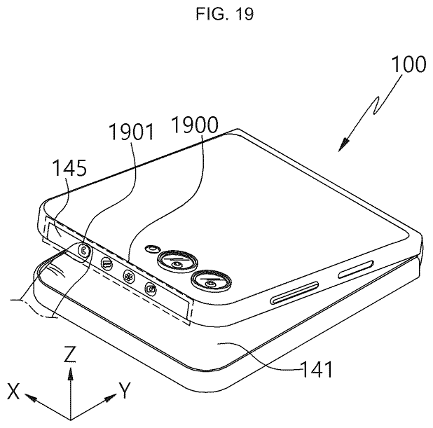

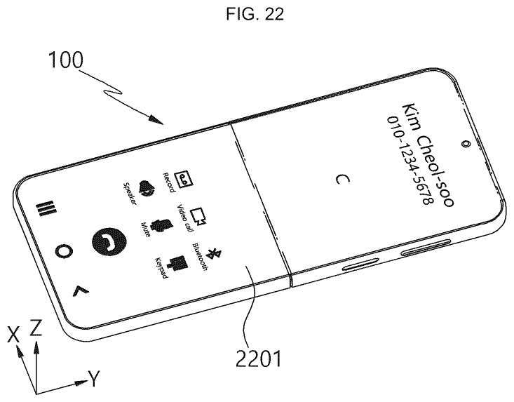

FIG. 18 is a flowchart illustrating an operation for controlling graphical interfaces displayed in the divided display areas of the flexible display in the device according to an embodiment of the present disclosure. FIGS. 19, 20, and 21 are perspective views illustrating operations for displaying a graphical interface of a first function based on each of unfolding angles of the foldable display area in the device according to some embodiments of the present disclosure. FIG. 22 is a perspective view illustrating an operation for displaying a graphical interface of a second function selected from the graphical interface of the first function in the foldable display area in the device according to an embodiment of the present disclosure.

Referring to FIG. 18, the processing unit 110 may detect that the angle between the first display area 141 and the second display area 143, which are divided by a foldable area in the flexible display, is unfolded to a first value within a first angular range (S1801).

According to an embodiment, the processing unit 110 may detect that the first display area 141 and the second display area 143 are unfolded to the first value (e.g., the second angle 403) within the first angular range (e.g., the Angular Range 2) based on a manipulation of the user.

The first value based on the manipulation of the user (e.g., the second angle 403) may be, for example, 20 degrees.

In addition, the Angular Range 2 may be a state in which the minimum value is greater than a maximum angle at which the angle between the first display area 141 and the second display area 143 can be unfolded in the Angular Range 1. For example, when the range of angles in the Angular Range 1 is greater than 0 degrees and less than 15 degrees, the minimum value of the Angular Range 2 may be 15 degrees or more.

In more detail, the Angular Range 2 may be defined as a range of 15 degrees or more and less than 25 degrees. However, the present disclosure is not limited thereto, and the Angular Range 2 may be variously changed as needed or desired depending on the setting.

While the first value is described above as the second angle 403 in the Angular Range 2, the present disclosure is not limited thereto, and the angle of the foldable display area may be unfolded to the third angle 405 in the Angular Range 3, the fourth angle 407 in the Angular Range 4, or the like, according to the manipulation of the user.

According to an embodiment, the angle (e.g., the first value) of the foldable display area manipulated by the user may be unfolded to various angles according to the manipulation of the user, such as the third angle 405 (e.g., 30 degrees) in the Angular Range 3 that may be 25 degrees or more and less than 35 degrees, the fourth angle 407 (e.g., 60 degrees) in the Angular Range 4 that may be 55 degrees or more and less than 65 degrees, or the like

According to the description above, the minimum and maximum values in the Angular Range 3 and the minimum and maximum values in the Angular Range 4 may be variously changed as needed or desired depending on the setting.

At least some of the operations of S1801 may be operations performed in S501 described above with reference to FIG. 5.

In S1803, the processing unit 110 may display an icon interface (e.g., a preset or predetermined icon interface, which may be a graphical interface) corresponding to the first angular range including the first value in the third display area 145.

According to an embodiment, as shown in FIG. 19, when the first value is the second angle 403, the processing unit 110 may call an icon display function (e.g., the first function) corresponding to the Angular Range 2 including the second angle 403.

In this case, the processing unit 110 may display a icon interface 1900 of the icon display function (e.g., the first function) for the Angular Range 2 in the third display area 145.

The icon interface may include at least one icon (e.g., a graphic symbol) configured to execute (e.g., call) a specific function of the device 100.

For example, the icon interface may include at least one icon for calling functions that may be operated in the device 100, such as a voice call icon, a message icon, a gallery icon, a photographing icon, a map icon, an Internet icon, a clock icon, a calendar icon, a contact icon, a search engine icon, or a mail icon, and/or the like. In addition, the icon interface may include a number (e.g., a preset or predetermined number) of icons, as shown in FIG. 19.

As such, the icon interface 1900 corresponding to the Angular Range 2 may include a plurality of icons, such as a voice call icon, a message icon, a photographing icon, and a gallery icon.

In addition, according to the description above, the manipulation of the user may be the second angle 403 in the Angular Range 2. However, the present disclosure is not limited thereto, and the processing unit 110 may detect that the angle (e.g., the first value) of the foldable display area is unfolded to the third angle 405, the fourth angle 407, or the like according to the manipulation of the user in S1801.

The Angular Range 3 or the Angular Range 4 may perform the icon display function (e.g., the first function).

In this case, when the third angle 405 is detected with respect to the angle of the foldable display area, the processing unit 110 may display an icon interface corresponding to the Angular Range 3 in the third display area 145, and when the fourth angle 407 is detected, may display an icon interface corresponding to the Angular Range 4 in the third display area 145.

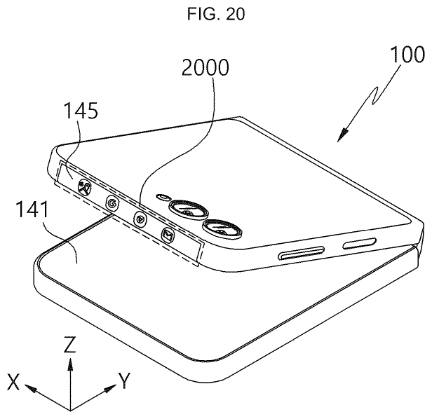

For example, as shown in FIG. 20, when it is determined that the angle (e.g., the first value) between the first display area 141 and the second display area 143 is unfolded to the third angle 405, the processing unit 110 may display an icon interface 2000 corresponding to the Angular Range 3 including the third angle 405 in the third display area 145.

According to an embodiment, the preset icon interface 2000 corresponding to the Angular Range 3 may include a map icon, a search engine icon, an Internet icon, and a mail icon.

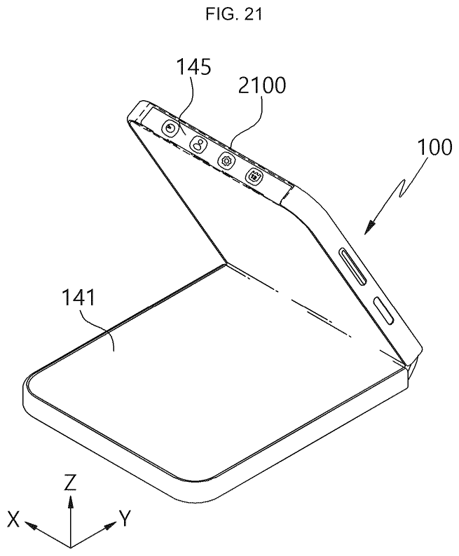

As another example, as shown in FIG. 21, when it is determined that the angle (e.g., the first value) between the first display area 141 and the second display area 143 is unfolded to the fourth angle 407, the processing unit 110 may display an icon interface 2100 corresponding to the Angular Range 4 including the fourth angle 407 in the third display area 145.

According to an embodiment, the icon interface 2100 corresponding to the Angular Range 4 may include a clock icon, a contact icon, a setting icon, and a calendar icon.

According to various embodiments, the icons included in the icon interfaces 1900, 2000, and 2100 may be variously changed as needed or desired depending on the setting. In addition, at least some of the icons included in the icon interfaces 1900, 2000, and 2100 may be included in two or more icon interfaces.

In an embodiment, the voice call icon is illustrated as being included in the icon interface 1900, but may also be included in the icon interface 2000, the icon interface 2100, or other icon interfaces.

At least some of the operations of S1803 may be operations performed in S503 described above with reference to FIG. 5.

In S1805, the processing unit 110 may call the voice call function (e.g., the second function) based on the touch gesture acquired through the third display area 145.

According to an embodiment, when acquiring a gesture input for selecting a voice call icon 1901 among the icons of the icon interface 1900 displayed in the third display area 145, the processing unit 110 may call the voice call function (e.g., the second function).

At least some of the operations of S1805 may be operations performed in S505 described above FIG. 5.

In S1807, the processing unit 110 may detect that the angle between the first display area 141 and the second display area 143 is changed to the second value within the second angular range.

According to an embodiment, the processing unit 110 may detect that the angle between the first display area 141 and the second display area 143 is unfolded to the second value (e.g., the eighth angle 415) in the second angular range (e.g., the Angular Range 8).

The second value (e.g., the eighth angle 415) based on the manipulation of the user may be, for example, 180 degrees.

The Angular Range 8 may be a state in which the angle between the first display area 141 and the second display area 143 is 180 degrees or less. In more detail, the Angular Range 8 may be defined as a range greater than the maximum value of the Angular Range 7 and 180 degrees or less. However, the present disclosure is not limited thereto, and the range of angles in the Angular Range 8 may be variously changed as needed or desired depending on the setting.

According to the description above, the angle of the foldable display area may be the eighth angle 415 (e.g., 180 degrees) according to the manipulation of the user. However, the present disclosure is not limited thereto, and the angle of the foldable display area may be unfolded to an angle (e.g., a specific or predetermined angle) (e.g., the sixth angle 411, the seventh angle 413, or the like) according to the manipulation of the user within the range of 90 degrees or more.

As described above, when it is detected that the angle of the foldable display area is changed to any value of 90 degrees or more, the processing unit 110 may perform S1809.

On the other hand, the processing unit 110 may detect that the angle of the foldable display area is changed to any value of less than 90 degrees.

In an embodiment, the second angle may be any angle within an angular range less than 90 degrees, which is set to perform the icon display function without being included in the first angular range (e.g., the Angular Range 2) of S1801.

For example, the processing unit 110 may detect that the second angle, which is unfolded based on the manipulation of the user, is unfolded to a second value (e.g., the fourth angle 407) within the second angular range (e.g., the Angular Range 4).

The second value (e.g., the fourth angle 407) based on the manipulation of the user may be, for example, 60 degrees.

In addition, the Angular Range 4 may be a state in which the minimum value is greater than a maximum angle at which the angle between the first display area 141 and the second display area 143 can be unfolded in the Angular Range 3. For example, as described above, the Angular Range 4 may be 55 degrees or more and less than 65 degrees.

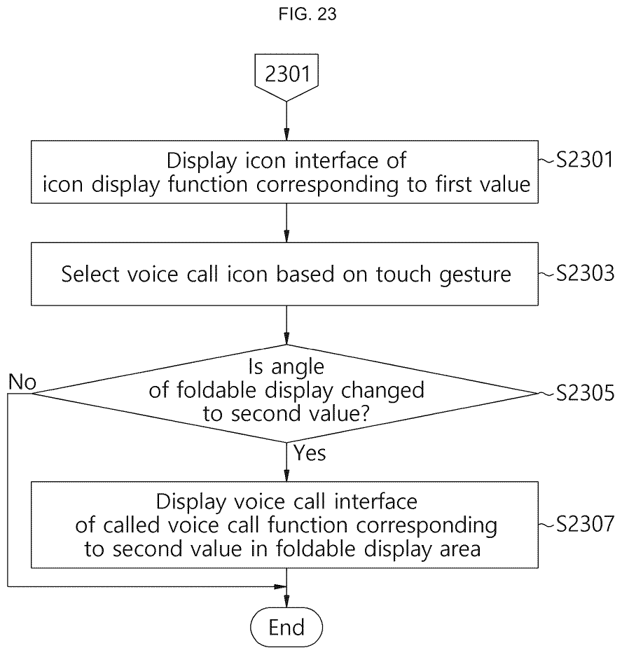

As described above, when it is detected that the angle of the foldable display area is changed to any value less than 90 degrees, the processing unit 110 may perform S2301 of FIG. 23.

At least some of the operations of S1807 may be operations performed in S507 described above with reference to FIG. 5.

In S1809, the processing unit 110 may display (e.g., the third function) a voice call interface (e.g., a graphical interface) of the voice call function (e.g., the second function) selected according to the touch gesture in at least a partial area of the first display area 141 and the second display area 143.

According to an embodiment, the processing unit 110 may display a graphical interface 2201 of the voice call function executed according to the touch gesture in the first display area 141 and the second display area 143.

The operation for displaying the voice call interface 2201 when the angle of the foldable display area is unfolded to the eighth angle 415 (e.g., 180 degrees) according to the manipulation of the user has been described above.

However, the present disclosure is not limited thereto, and when it is detected that the angle of the foldable display area is unfolded to an angle (e.g., a specific or predetermined angle) (e.g., the sixth angle 411, the seventh angle 413, or the like) within the range of 90 degrees or more according to the manipulation of the user, the processing unit 110 may display the voice call interface 2201 in the first display area 141 and the second display area 143.

In more detail, when it is detected that the angle of the foldable display area is unfolded to an angle (e.g., a specific or predetermined angle) within the angular range of 90 degrees or more while the second function is called by a selection of an icon, the processing unit 110 may display a graphical interface of the corresponding second function (e.g., the third function) in the first display area 141 and the second display area 143.

At least some of the operations of S1809 may be operations performed in S509 described above with reference to FIG. 5.

When the execution of S1809 is completed, the processing unit 110 may terminate the method/operation of the fifth embodiment illustrated in FIG. 18 (e.g., the method/operation may end).

Hereinafter, some of the method/operation according to a sixth embodiment may be described in more detail hereinafter with reference to FIGS. 23 to 25.

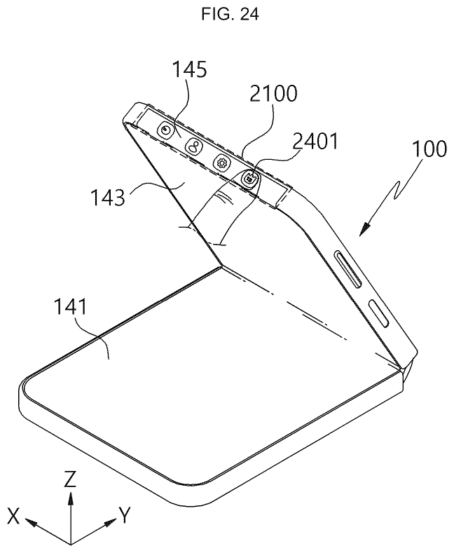

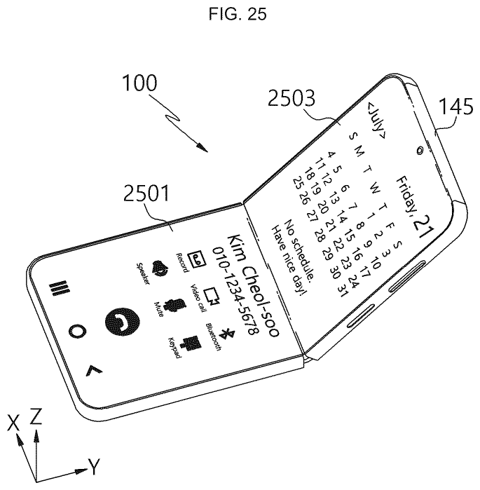

FIG. 23 is a flowchart illustrating an operation for controlling graphical interfaces to be displayed in the divided display areas of the flexible display in the device according to an embodiment of the present disclosure. FIG. 24 is a perspective view illustrating an operation for selecting the second function through the graphical interface of the first function displayed based on each of unfolding angles of the foldable display area in the device according to an embodiment of the present disclosure. FIG. 25 is a perspective view illustrating an operation for displaying a plurality of graphical interfaces of a plurality of second functions selected from a plurality of graphical interfaces of a plurality of first functions in the foldable display area in the device according to an embodiment of the present disclosure.

The sixth embodiment may refer to an operation performed by the device 100 after S1801 to S1805 of the fifth embodiment described above with reference to FIG. 18 are performed identically or similarly, and then the angle of the foldable display area is changed to a value less than 90 degrees in S1807.

Hereinafter, with reference to FIG. 23, the first value expressed in the embodiment of FIG. 18 is described as a first-1 value, the first angular range is described as a first-1 angular range, the first function (e.g., the icon display function corresponding to the Angular Range 2 including the second angle 403) is described as a first-1 function, the second value is described as a first-2 value, the second angular range is described as a first-2 angular range, and the second function (e.g., the voice call function) is described as a second-1 function.

Similarly, the first value indicated in FIG. 23 is described for consistency with FIG. 18, and in the following description, the first value indicated in FIG. 23 may be described as a first-2 value.

In other words, the second value described above with reference to FIG. 18 may be the same as the first value shown in FIG. 23, and will be described as the first-2 value in describing the embodiment of FIG. 23 below.

In S2301, the processing unit 110 may display a preset icon interface (e.g., a graphical interface) corresponding to the first-2 angular range including the first-2 value in the third display area 145.

According to an embodiment, as shown in FIGS. 21 and 24, when the first-2 value is the fourth angle 407, the processing unit 110 may call an icon display function (first-2 function) corresponding to Angular Range 4 including the fourth angle 407.

In this case, the processing unit 110 may display the preset icon interface 2100 of the icon display function (first-2 function) for Angular Range 4 in the third display area 145.

According to an embodiment, the preset icon interface 2100 corresponding to the Angular Range 4 may include a clock icon, a contact icon, a setting icon, and a calendar icon 2401.

At least some of the operations of S2301 may be operations performed in the same or similar manner as the operations of S1803.

In S2303, the processing unit 110 may call a gallery function (second-2 function) based on the touch gesture acquired through the third display area 145.

According to an embodiment, the processing unit 110 may acquire a touch gesture for selecting the calendar icon 2401 among the icons of the icon interface 2100 displayed in the third display area 145, as shown in FIG. 24. The processing unit 110 may call a calendar function (second-2 function) corresponding to the touch gesture for selecting the calendar icon 2401.

At least some of the operations of S2303 may be operations performed in the same or similar manner as the operations of S1805.

In S2305, the processing unit 110 may detect that the angle between the first display area 141 and the second display area 143 is changed to the second value within the second angular range.

According to an embodiment, the processing unit 110 may detect that the angle between the first display area 141 and the second display area 143 is unfolded to a value greater than an angle (e.g., a specific or predetermined angle) (e.g., 90 degrees).

For example, the processing unit 110 may detect that the angle between the first display area 141 and the second display area 143 is unfolded to a second value (e.g., the seventh angle 413) within a second angular range (e.g., the Angular Range 7).

The second value (e.g., the seventh angle 413) based on the manipulation of the user may be, for example, 160 degrees.

In this case, the Angular Range 7 may be defined as a range greater than the maximum value of the Angular Range 6 and less than the minimum value of the Angular Range 8. According to an embodiment, the Angular Range 7 may be a value in which the angle between the first display area 141 and the second display area 143 is 155 degrees or more and less than 165 degrees. However, the present disclosure is not limited thereto, and the range of angles in the Angular Range 7 may be variously changed as needed or desired depending on the setting.

According to the description above, the angle of the foldable display area may be the seventh angle 413 (e.g., 160 degrees) according to the manipulation of the user. However, the present disclosure is not limited thereto, and the angle of the foldable display area may be unfolded to an angle (e.g., a specific or predetermined angle) (e.g., the sixth angle 411, the eighth angle 415, or the like) according to the manipulation of the user within a range of 90 degrees or more.

As described above, when it is detected that the angle between the first display area 141 and the second display area 143 is changed to a second value (e.g., the value of 90 degrees or more) within a second angular range (e.g., an angular range consisting of the minimum value and the maximum value of 90 degrees or more), the processing unit 110 may perform S2307.

On the other hand, if (e.g., when) the angle between the first display area 141 and the second display area 143 is not changed, the processing unit 110 may terminate the method/operation of the embodiment in FIG. 23 (e.g., the method/operation may end).

At least some of the operations of S2305 may be operations performed in S507 described above with reference to FIG. 5.

In S2307, the processing unit 110 may display (e.g., the third function) a voice call interface (graphical interface) of the voice call function (second-1 function) selected according to the touch gesture and a calendar interface (graphical interface) of the calendar function (second-2 function) in at least a partial area among the first display area 141 and the second display area 143.

According to an embodiment, the processing unit 110 may display a voice call interface 2501 of the voice call function (second-1 function) and a calendar interface 2503 of the calendar function (second-2 function) in the first display area 141 and the second display area 143, as shown in FIG. 25.

At least some of the operations in S2307 may be operations performed in S509 described above with reference to FIG. 5.

When the execution of S2307 is completed, the processing unit 110 may terminate the method/operation of the sixth embodiment based on FIG. 23.

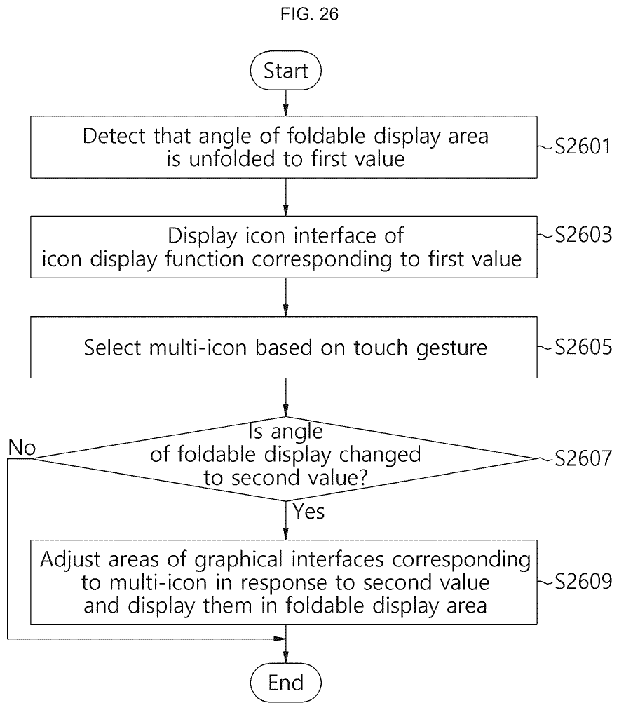

Hereinafter, a seventh embodiment performed by the device 100 will be described in more detail based on FIGS. 26 to 30.

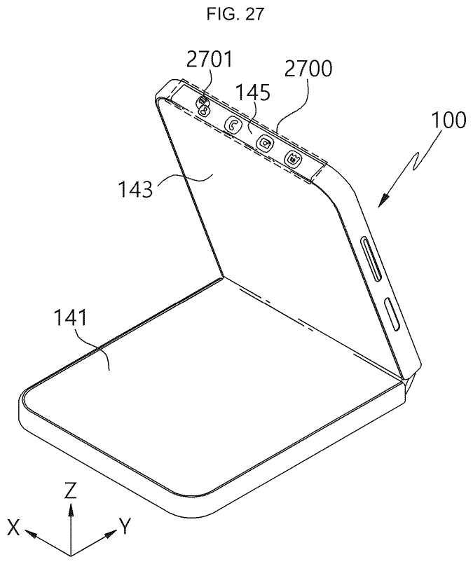

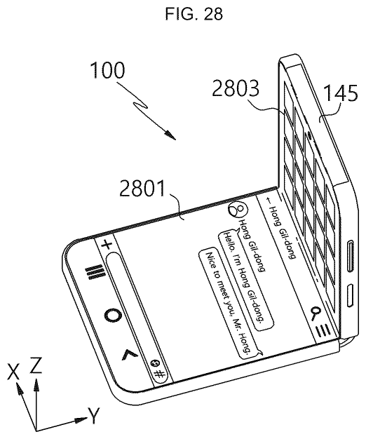

FIG. 26 is a flowchart illustrating an operation for controlling graphical interfaces to be displayed in the divided display areas of the flexible display in the device according to an embodiment of the present disclosure. FIG. 27 is a perspective view illustrating an operation for displaying the graphical interface of the first function based on the unfolding angle of the foldable display area in the device according to an embodiment of the present disclosure. FIGS. 28, 29, and 30 are perspective views illustrating operations for displaying graphical interfaces for the plurality of second functions on the foldable display area based on the unfolding angle of the foldable display area in a device according to some embodiments of the present disclosure.

In S2601, the processing unit 110 may detect that the angle between the first display area 141 and the second display area 143, which are divided by on a foldable area in the flexible display, is unfolded to a first value within a first angular range.

According to an embodiment, the processing unit 110 may detect that the first display area 141 and the second display area 143 are unfolded to the first value (e.g., the fifth angle 409) within the first angular range (e.g., the Angular Range 5) based on the manipulation of the user.

The first value (e.g., the fifth angle 409) based on the manipulation of the user may be, for example, 70 degrees.

In addition, the Angular Range 5 may be a state in which the minimum value is a value greater than a maximum angle at which the angle between the first display area 141 and the second display area 143 can be unfolded in the Angular Range 4. For example, the minimum value of the Angular Range 5 may be 65 degrees or more.

In more detail, the Angular Range 5 may be defined as a range of 65 degrees or more and less than 75 degrees. However, the present disclosure is not limited thereto, and the Angular Range 5 may be variously changed as needed or desired depending on the setting.

In addition, although the first value is described as the fifth angle 409 of the Angular Range 5, the present disclosure is not limited thereto, and the angle of the foldable display area may be unfolded to any angle within 90 degrees according to the manipulation of the user.

At least some of the operations of S2601 may be operations performed in S501 described above with reference to FIG. 5.

In S2603, the processing unit 110 may display a preset icon interface (graphical interface) corresponding to the first angular range including the first value in the third display area 145.

According to an embodiment, as shown in FIG. 27, the processing unit 110 may call an icon display function (e.g., the first function) corresponding to the Angular Range 5 including a fifth angle 409 when the first value is the fifth angle 409.

In this case, the processing unit 110 may display a preset icon interface 2700 of an icon display function (e.g., the first function) for the Angular Range 5 in the third display area 145.

According to an embodiment, the preset icon interface 2700 corresponding to the Angular Range 5 may include at least one icon set to call two or more functions simultaneously.

For example, the icon interface 2700 may include a multi-icon 2701 set to call a message function and a gallery function simultaneously, and/or at least one icon set to call another function that can be performed in the device 100.

The message function may include a function provided for conversation between users, such as a short message service (SMS) or an instant messenger.

The multi-icon may be an icon set to simultaneously call two or more functions (e.g., preset programs) selected based on the user input.

However, the multi-icon 2701 may be an icon created in the device 100 when two or more functions are being displayed through the first display area 141 and the second display area 143, and in this state, the corresponding functions are switched to background execution.

Referring to FIG. 27, the icon interface 2700 is illustrated as including one multi-icon 2701, but the present disclosure is not limited thereto, and may include two or more multi-icons depending on the setting.

At least some of the operations of S2603 may be operations performed in S503 described above with reference to FIG. 5.

In S2605, the processing unit 110 may call a function (e.g., the second function) of the multi-icon based on the touch gesture acquired through the third display area 145.

According to an embodiment, when acquiring a gesture input for selecting the multi-icon 2701 among the icons of the icon interface 2700 displayed in the third display area 145, the processing unit 110 may call functions (e.g., the message function and the gallery function) (e.g., the second function) set for the multi-icon.

At least some of the operations of S2605 may be operations performed in S505 described above with reference to FIG. 5.

In S2607, the processing unit 110 may detect that the angle between the first display area 141 and the second display area 143 is changed to a second value within a second angular range.

According to an embodiment, the processing unit 110 may detect that the angle between the first display area 141 and the second display area 143 is unfolded to the second value within the second angular range (e.g., 90 degrees or more).

According to an embodiment, the second angular range may be a state where the minimum value is set to be 90 degrees and the maximum value is set to be a maximum unfoldable value of the foldable display area (e.g., 180 degrees).

As described above, when it is detected that the angle between the first display area 141 and the second display area 143 is changed to the second value (e.g., the value of 90 degrees or more) within the second angular range (e.g., the angular range formed of the minimum value and the maximum value of 90 degrees or more), the processing unit 110 may perform S2607.

On the other hand, if (e.g., when) the angle between the first display area 141 and the second display area 143 is not changed, the processing unit 110 may terminate the method/operation of embodiment in FIG. 26.

At least some of the operations of S2607 may be operations performed in S507 described above with reference to FIG. 5.

In S2609, the processing unit 110 may display at least some interfaces among the message interface (graphical interface) and the calendar interface (graphical interface) of the functions (e.g., the second function) of the multi-icon selected according to the touch gesture through the first display area 141 and the second display area 143.

According to an embodiment, the processing unit 110 may adjust a ratio of the message interface and the calendar interface displayed in the first display area 141 and the second display area 143 corresponding to the angle of the second value.

For example, referring to FIG. 28, when the angle of the second value is 90 degrees, the processing unit 110 may display a message interface 2801 in the first display area 141 (or the second display area 143), and may display a gallery interface 2803 in the second display area 143 (or the first display area 141).

As another example, when the angle of the second value is any angle within the range of 90 degrees or more (e.g., 90 degrees or more to 180 degrees or less), the processing unit 110 may adjust the area sizes of the interfaces according to priorities of the functions of the multi-icon, and may display them in the first display area 141 and the second display area 143.

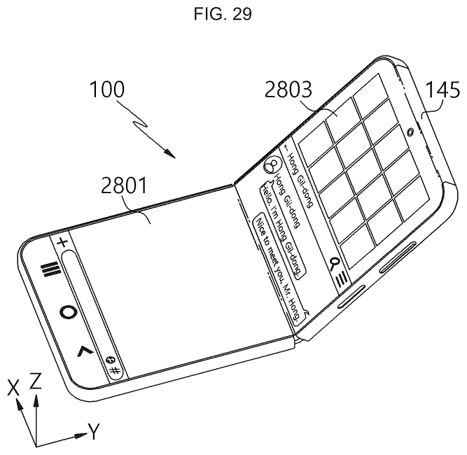

In more detail with reference to FIG. 29, when it is determined that the angle of the second value with respect to the foldable display area is 135 degrees, the processing unit 110 may increase the size of the graphical interface (message interface 2801) area of a function having a higher priority (message function) displayed in the first display area 141 and the second display area 143 in proportion to the second value, and may decrease the size of the graphical interface (gallery interface 2803) area of a function having a lower priority (gallery function).

Accordingly, the processing unit 110 may extend the size so that the area of the message interface 2801 encroaches into the area of the gallery interface 2803 displayed in the second display area 143.

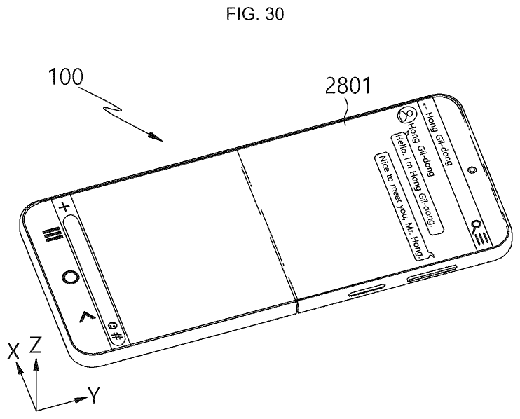

As another example, with reference to FIG. 30, when the angle of the second value is the maximum unfoldable angle (e.g., 180 degrees), the processing unit 110 may display a graphical interface (message interface 2801) of a function (e.g., the message function) which is preset to have a higher priority between the message interface 2801 and the gallery interface 2803, in the first display area 141 and the second display area 143.

In more detail, when the angle of the second value is the maximum unfoldable angle (e.g., 180 degrees), the processing unit 110 may extend the message interface 2801 of the function having a high priority (e.g., the message function) to display it in full screen in the first display area 141 and the second display area 143.

In this case, as the size of the graphical interface area displayed in the first display area 141 and the second display area 143 is increased, the amount of content displayed for the corresponding function may be increased. On the other hand, as the size of the graphical interface area displayed in the first display area 141 and the second display area 143 is decreased, the amount of content displayed for the corresponding function may be decreased.

At least some of the operations of S2609 may be operations performed in S509 described above with reference to FIG. 5.

When the execution of S2609 is completed, the processing unit 110 may terminate the method/operation of the seventh embodiment based on FIG. 26.

According to various embodiments, after displaying at least some of the graphical interfaces (e.g., the message interface 2801 and the gallery interface 2803) for a plurality of functions (e.g., the message function and the gallery function) in the first display area 141 and the second display area 143 according to the second value in S2609 or after S2609, the processing unit 110 may detect that the angle of the foldable display area is changed (e.g., changed to a third value) according to the manipulation of the user.

The third value may be any value within the minimum value (e.g., 90 degrees) to the maximum value (e.g., 180 degrees) of the second angular range set to display at least one graphical interface for the selected functions in at least a partial area of the first display area 141 and the second display area 143.

In this case, the processing unit 110 may adjust the area size of the message interface 2801 and/or the gallery interface 2803 displayed in the first display area 141 and the second display area 143 in proportion to the angle change of the foldable display area.

The change in the size of the graphical interface area for the plurality of functions according to the angle change of the foldable display area will be described in more detail based on at least a portion of the drawings of FIGS. 28 to 30.

According to an embodiment, when the angle of the foldable display area is 90 degrees as shown in FIG. 28, the third value may be adjusted in a direction in which the angle of the foldable display area is increased.

In this case, the processing unit 110 may expand the size of the message interface 2801 area of the function having a higher priority (e.g., the message function) corresponding to the angle of the third value to encroach into the second display area 143 as shown in FIG. 29. Accordingly, the processing unit 110 may expand the display content corresponding to the expanded message interface 2801 area.

In this case, when the processing unit 110 controls the size of the message interface 2801 area to encroach into the second display area 143 by expanding it, the size of the gallery interface 2803 area displayed in the second display area 143 may be reduced corresponding thereto. Accordingly, the processing unit 110 may reduce the display content corresponding to the reduced gallery interface 2803 area.

According to various embodiments, the angle of the third value may be increased from a state of any one angle within the second angular range as shown in FIG. 29 to the maximum angle (e.g., 180 degrees) that can be unfolded by increasing the angle of the third value.

In this case, the processing unit 110 may expand the size of the message interface 2801 area of the message function having a higher priority in proportion to the angle of the third value, and display it in full screen in the first display area 141 and the second display area 143.

In this case, the processing unit 110 may remove the display of the gallery interface 2803 in the second display area 143 as shown in FIG. 30.

In performing the operation for expanding the area size of the message interface 2801 displayed in the foldable display area and reducing the area size of the gallery interface 2803, the processing unit 110 may apply an animation effect to correspond to a change in the angle between the first display area 141 and the second display area 143.

According to various embodiments, when the angle of the foldable display area is 90 degrees as shown in FIG. 28, the third value may be adjusted in a direction in which the angle of the foldable display area is decreased.

In this case, the processing unit 110 may reduce the size of the message interface 2801 area of the function having a higher priority (e.g., the message function) corresponding to the angle of the third value. Accordingly, the processing unit 110 may reduce the displayed content corresponding to the reduced area of the message interface 2801.

In this case, when the processing unit 110 controls the size of the message interface 2801 area to be reduced from the full screen, the gallery interface 2803 area that has been removed may be expanded toward the first display area 141 and displayed corresponding thereto. The processing unit 110 may expand the display content to correspond to the extended gallery interface 2803 area.

According to various embodiments, the angle of the third value may be decreased from a state of any one angle within the second angular range as shown in FIG. 29 to reduced minimum angle (e.g., 90 degrees) for displaying the graphical interfaces by decreasing the angle of the third value.

In this case, the processing unit 110 may display the message interface 2801 in the first display area 141 and the gallery interface 2803 in the second display area 143 by reducing the size of the message interface 2801 area of the message function having a higher priority in proportion to the angle of the third value.

In performing the operation for reducing the area size of the message interface 2801 displayed in the foldable display area and expanding the area size of the gallery interface 2803, the processing unit 110 may apply an animation effect to correspond to the angle change of the first display area 141 and the second display area 143.

According to various embodiments, the processing unit 110 may display a graphical interface for controlling at least some functions (or at least a partial detailed function) performed in the device 100 through the third display area 145.

In this case, the processing unit 110 may display a graphical interface of an adjustable function (or a detailed function) for each of at least one angular range in the angle of the foldable display area.

In more detail, the device 100 may display a graphical interface for controlling the brightness of the device 100 (e.g., the brightness of the foldable display area) for the first angular range in the third display area 145, and may display a graphical interface for controlling the volume of the device 100 for the second angular range in the third display area 145.

When the angle of the foldable display area is adjusted to the first value within the first angular range according to the manipulation of the user, the processing unit 110 may display the graphical interface for controlling the brightness of the device 100 in the third display area 145.

Thereafter, the processing unit 110 may control the brightness of the device 100 based on the touch gesture of the user input through the third display area 145.

According to an embodiment, when acquiring a touch gesture of dragging to one side in the longitudinal direction through the third display area 145, the processing unit 110 may increase the brightness of the foldable display area.

On the other hand, when acquiring a touch gesture of dragging to the other side in the longitudinal direction through the third display area 145, the processing unit 110 may decrease the brightness of the foldable display area.

In addition, when the angle of the foldable display area is adjusted to the second value within the second angular range according to the manipulation of the user, the processing unit 110 may display the graphical interface for controlling the volume of the device 100 in the third display area 145.

Thereafter, the processing unit 110 may control the volume of the device 100 based on the touch gesture of the user input through the third display area 145.

According to an embodiment, when acquiring a touch gesture of dragging to one side in the longitudinal direction through the third display area 145, the processing unit 110 may increase the volume of the device 100.

On the other hand, when acquiring a touch gesture of dragging to the other side in the longitudinal direction through the third display area 145, the processing unit 110 may decrease the volume of the device 100.

According to various embodiments of the present disclosure, the configuration, in which the processing unit 110 determines the touch gesture such as a leftward drag, a rightward drag, an upward drag, or a downward drag for display areas (e.g., the third display area 145), and controls to perform the preset function or the detailed function corresponding to the determined touch gesture, has been described.

However, the directions of the touch gesture input through the display areas of the device 100 or the functions (or detailed functions) set to be performed corresponding to the input touch gesture are examples for describing how the device 100 according to various embodiments of the present disclosure operates (or how the processing unit 110 controls the operation).

Therefore, the directions of the touch gesture for the device 100 and/or the functions (or detailed functions) set to be performed corresponding thereto may be set differently during a production process of the device 100 or may be modified or changed after production, and it should be understood that such changes are also included in the scope of the present disclosure.

According to one or more embodiments of the present disclosure, a foldable mobile phone may comprise: a flexible display comprising: a foldable area; a first display area and a second display area on a first plane, and divided based on the foldable area; and a third display area on a second plane extending from the first plane at a predetermined angle toward the second display area from the outside; and a processor configured to: detect that an angle between the first display area and the second display area is unfolded to a first value within a first angular range; display a graphical interface of a first function in the third display area based on the first value; execute a selected second function based on a user input selecting the second function in the graphical interface; detect that the angle between the first display area and the second display area is changed to a second value within a second angular range; and perform a third function through at least a partial area of the first display area or the second display area based on the second value.

In an embodiment, the foldable mobile phone may further comprise a hinge configured to guide an unfolding of the first display area and the second display area, wherein the first display area and the second display area may be adjacent to each other based on the foldable area defined by the hinge, and wherein the third display area may be bent at the predetermined angle with respect to the second display area.

In an embodiment, the graphical interface of the first function may comprise an icon or a gesture input interface configured to call the second function, and wherein the processor may be configured to acquire the user input selecting the icon or inputting a touch gesture to call the second function into the gesture input interface.

As described above, according to various embodiments of the present disclosure, the device 100 has effects of providing the same function of an auxiliary display while reducing production costs of the device 100 by forming a part of the flexible display to be exposed to outside of the device 100 and omitting the auxiliary display configured independently of the flexible display.

According to various embodiments of the present disclosure, the device 100 has effects of providing a bespoke exterior of the device 100 while maintaining the design advantage of the foldable device 100 by omitting the auxiliary display configured outside the device 100 independently of the flexible display inside thereof.

According to the detailed description of the present disclosure, the functions of various embodiments described as being performed by the device 100 are operations processed through the processing unit 110 of the device 100, and may be performed by organically being connected to the device 100 and/or components of the device connected to the device 100.

In the present disclosure, any function performed by the device 100 has been described through various embodiments, but if a component that performs the corresponding function is not described as a component of the device 100, it should be understood that the device 100 includes a commonly known component that performs the function and/or is connected thereto.

As described above, although the embodiments have been described with reference to the limited drawings, it will be apparent to those skilled in the art that various modifications and alternations may be applied thereto based on the various embodiments.

For example, adequate effects or results may be achieved even if the foregoing processes and methods are carried out in different order than those described above, and/or the above-described elements, such as systems, structures, devices, or circuits, are combined or coupled in different forms and modes than those described above, or substituted or switched with other components or equivalents.

In particular, when describing with reference to the flowchart, it has been described that a plurality of processes are configured and the processes are sequentially executed in a designated order, but it is not necessarily limited to the designated order.

In other words, executing by changing or deleting at least some of the processes described in the flowchart or adding at least one process is applicable as an embodiment, and executing one or more processes in parallel may also be applicable as an embodiment. In other words, it is not limited to that the processes are necessarily operated in a time-series order, and should be included in various embodiments of the present disclosure.

The electronic or electric devices and/or any other relevant devices or components according to embodiments of the present disclosure described herein (e.g., the processing unit, the communication unit, and the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A method for controlling an operation of a foldable device comprising a first display area and a second display area on a first plane of a flexible display and divided based on a foldable area in the flexible display, and a third display area on a second plane extending from the first plane at a predetermined angle toward the second display area from the outside, the method comprising:
detecting that an angle between the first display area and the second display area is unfolded to a first value within a first angular range;
displaying a graphical interface of a first function in the third display area based on the first value;
executing a selected second function based on a user input selecting the second function in the graphical interface;
detecting that the angle between the first display area and the second display area is changed to a second value within a second angular range; and
performing a third function through at least a partial area of the first display area or the second display area based on the second value.

2. The method according to claim 1, wherein the first display area and the second display area are adjacent to each other based on the foldable area comprising a hinge, and
wherein the third display area is bent at the predetermined angle with respect to the second display area.

3. The method according to claim 1, wherein the graphical interface of the first function comprises an icon or a gesture input interface configured to call the second function, and
wherein the user input comprises selecting the icon or inputting a touch gesture to call the second function into the gesture input interface.

4. The method according to claim 1, wherein a maximum value of the first angular range comprises a value smaller than a minimum value of the second angular range.

5. The method according to claim 1, wherein the third function is determined based on the executed second function and the second angular range.

6. The method according to claim 1, wherein, when the second value is a maximum value of the angle that can be formed between the first display area and the second display area, the performing of the third function through at least a partial area of the first display area or the second display area comprises displaying a control interface configured to control an operation of the third function in the third display area.

7. The method according to claim 1, wherein the graphical interface of the first function comprises at least one multi-icon configured to call two or more programs, and
wherein the user input comprises selecting the multi-icon through a touch gesture.

8. The method according to claim 7, wherein the performing of the third function through at least a partial area of the first display area or the second display area comprises:
dividing area sizes of each of graphical interfaces corresponding to two or more programs of the selected multi-icon corresponding to the second value; and
displaying the graphical interfaces in the first display area and the second display area.

9. The method according to claim 1, wherein before the detecting of the angle between the first display area and the second display area is changed to the second value within the second angular range, the method further comprises:
detecting that the first display area and the second display area are unfolded to a third value within a third angular range;
displaying a graphical interface of a fourth function corresponding to the third angular range in the third display area; and
executing a selected fifth function based on a user input selecting the fifth function in the graphical interface of the third function,
wherein the performing of the third function through at least a partial area of the first display area or the second display area comprises:
dividing area sizes of each of the graphical interface of the second function and a graphical interface of the fifth function corresponding to the second value; and
displaying the graphical interfaces of the second function and the fifth function in the first display area and the second display area, and
wherein each of the graphical interface of the first function and the graphical interface of the fourth function comprises at least one icon configured to call a program.

10. The method according to claim 9, wherein the first angular range and the third angular range do not overlap with each other, and
wherein a maximum value of the first angular range and a maximum value of the third angular range are smaller than a minimum value of the second angular range.

11. An electronic device for controlling an operation of display areas in a foldable device, the electronic device comprising:
a first display area and a second display area on a first plane of a flexible display, and divided based on a foldable area in the flexible display;
a third display area on a second plane extending from the first plane at a predetermined angle toward the second display area from the outside;
a storage device configured to store content; and
a processor to process the content to be displayed on the flexible display,
wherein the processor is configured to:
detect that an angle between the first display area and the second display area is unfolded to a first value within a first angular range;
display a graphical interface of a first function in the third display area based on the first value;
execute a selected second function based on a user input selecting the second function in the graphical interface;
detect that the angle between the first display area and the second display area is changed to a second value within a second angular range; and
perform a third function through at least a partial area of the first display area or the second display area based on the second value.

12. The electronic device according to claim 11, further comprising a hinge configured to guide an unfolding of the first display area and the second display area,
wherein the first display area and the second display area are adjacent to each other based on the foldable area defined by the hinge, and
wherein the third display area is bent at the predetermined angle with respect to the second display area.

13. The electronic device according to claim 11, wherein the graphical interface of the first function comprises an icon or a gesture input interface configured to call the second function, and
wherein the processor is configured to acquire the user input selecting the icon or inputting a touch gesture to call the second function into the gesture input interface.

14. The electronic device according to claim 11, wherein a maximum value of the first angular range is smaller than a minimum value of the second angular range.

15. The electronic device according to claim 11, wherein the third function is determined based on the executed second function and the second angular range.

16. The electronic device according to claim 11, wherein, when the second value is a maximum value that the angle can be formed between the first display area and the second display area, the processor is configured to display a control interface configured to control an operation of the third function in the third display area.

17. The electronic device according to claim 11, wherein the graphical interface of the first function comprises at least one multi-icon configured to call two or more programs, and
wherein the processor is configured to acquire the user input selecting the multi-icon through a touch gesture.

18. The electronic device according to claim 17, wherein the processor is configured to perform the third function by dividing area sizes of each of graphical interfaces corresponding to two or more programs of the selected multi-icon corresponding to the second value, and displaying the graphical interfaces in the first display area and the second display area.

19. The electronic device according to claim 11, wherein before the detecting that the angle between the first display area and the second display area is changed to the second value within the second angular range, the processor is configured to:
detect that the first display area and the second display area are unfolded to a third value within a third angular range;
display a graphical interface of a fourth function corresponding to the third angular range in the third display area; and
execute a selected fifth function based on a user input selecting the fifth function in the graphical interface of the third function,
wherein the processor is further configured to perform the third function by dividing area sizes of each of the graphical interface of the second function and a graphical interface of the fifth function corresponding to the second value, and displaying the graphical interfaces in the first display area and the second display area, and
wherein each of the graphical interface of the first function and the graphical interface of the fourth function comprises at least one icon configured to call a program.

20. The electronic device according to claim 19, wherein the first angular range and the third angular range do not overlap with each other, and
wherein a maximum value of the first angular range and a maximum value of the third angular range are smaller than a minimum value of the second angular range.
